(19) United States
(12) Patent Application Publication
(10) Pub. No.: US 2026/0302309 A1
(43) Pub. Date: Oct. 1, 2026

(54) DEVICE AND METHOD FOR THE ENERGY CELL MANUFACTURING INDUSTRY FOR FORMING A STACK COMPRISING A PLURALITY OF SEGMENTS AND A MATERIAL WEB

(71) Applicant: KÖRBER TECHNOLOGIES GMBH, Hamburg (DE)

(72) Inventors: Jan KREYSERN, Hamburg (DE); Karsten MEINKE, Mölln (DE); Manfred FOLGER, Hamburg (DE); Michael KLEINE WÄCHTER, Lankau (DE)

(21) Appl. No.: 19/479,145

(22) PCT Filed: Apr. 26, 2024
(86) PCT No.: PCT/EP2024/061592

§ 371 Date: Oct. 27, 2025

(30) Foreign Application Priority Data
Apr. 28, 2023 (DE) 10 2023 111 022.5

(51) Int. Cl. H01M 10/04; B65H 29/44; B65H 45/20

(52) U.S. Cl. CPC H01M 10/0431; B65H 29/44; B65H 45/20; H01M 10/0404; B65H 2301/44714; B65H 2406/33; B65H 2801/72

(57) ABSTRACT

Device for the energy cell manufacturing industry for forming a stack comprising a plurality of segments and a material web, wherein the device is designed to fold the material web in a zigzag manner and to deposit the segments on the material web such that, in the stack, the segments are arranged in the folds of the material web, wherein the device comprises the following components: a stacking table on which the stack is formed, a material web feed apparatus which is designed to convey the material web to the stacking table, and a first and/or a second segment feed apparatus, each designed to transport sections to the stacking table, wherein the first and/or the second segment feed apparatuses each comprise at least one rotational body which is rotatably mounted about an axis of rotation and which is designed to transport sections via a rotational movement.

The present invention relates to a device for the energy cell manufacturing industry for forming a stack that comprises a plurality of segments and a material web, in accordance with the preamble of claim 1, as well as a corresponding method in accordance with the preamble of claim 33.

Known in principle from the prior art is the use of energy cells or even energy storage devices in motor vehicles, other land vehicles, ships, aircraft or even in stationary systems in the form of battery cells or fuel cells in which large amounts of energy can be stored over longer periods of time. For this purpose, such energy cells have a structure consisting of a plurality of segments stacked to form a stack, between which another material is arranged. The segments can, for example, be designed as electrode webs so that anode and cathode sheets alternatingly follow each other in the stack; in such a case, a layer of a separator web is arranged between two adjacent electrode sheets.

In accordance with a first variant, the separators can be arranged in the form of individual separator sheets between the electrodes. In accordance with a second variant, it is also known to place the separator in the form of a material web by forming a zigzag-shaped folding geometry, i.e., by a so-called Z-fold, around the segments.

To form the Z-fold, it is known in principle from the prior art to form the cell stack on a stacking table that is mounted so that it can be moved horizontally. In a first deposit position, an anode sheet is placed on a separator web stretched over the stacking table. By displacing the stacking table horizontally to a second deposit position, the separator web is placed or folded around the laid anode sheet. A cathode sheet is then placed on the separator web in the second deposit position. By a horizontal movement of the stacking table back to the first deposit position, the separator web is placed or folded around the cathode sheet so that an anode sheet can be placed thereon again after the first deposit position has been reached. This process is repeated until the desired cell stack height is reached, i.e., the cell stack is completed. In this way, the Z-fold mentioned at the beginning can be realized in manufacturing.

It is an object of the present application to present an improved device for the energy cell manufacturing industry for forming a stack that comprises a plurality of segments and a material web with a Z-fold, as well as a correspondingly improved method.

The object is achieved by the features of the independent claims. Further preferred embodiments of the invention can be found in the dependent claims, the figures, and the associated description.

At this juncture, some terms used in the context of the present application will first be explained:

A rotational body within the meaning of the present application is any body that is rotatably mounted. The geometry of the body is not further defined by the term.

When within the scope of this application an endless web is mentioned, this obviously does not mean an endless web in the literal sense, but rather a web that can be continuously fed during production. The feed will only be interrupted by the provision of a new web. In practice, endless webs are formed, for example, by connecting two webs that are wound on so-called coils, also called bobbins. During the production process, the web is then unwound from the coil. The aim is to connect the web of an expiring (old) coil with the web of a new coil without interrupting the production process so that the web is in principle endlessly fed during production.

A stacking table within the meaning of the present application is a device which has a deposit surface on which a stack can be formed. The deposit surface does not necessarily have to be smooth or continuous; it can also have recesses such as holes, bars or gaps, for example. The holes, for example, are continuous openings that extend from the top to the bottom of the deposit surface. Alternatively or additionally, the deposit surface can also comprise vacuum holes.

A fold within the meaning of the present application is understood to mean any type of fold. The fold edge therefore does not necessarily have to be sharply peaked. This also includes folds with rounded fold edges.

In accordance with a first aspect of this application, the object is achieved by a device for the energy cell manufacturing industry for forming a stack comprising a plurality of segments and a material web, wherein the device is designed to fold the material web in a zigzag manner and to deposit the segments on the material web such that, in the stack, the segments are arranged in the folds of the material web, wherein the device comprises the following components: a stacking table on which the stack is formed, a material web feed apparatus which is designed to convey the material web to the stacking table, and a first and/or a second segment feed apparatus, each designed to transport sections to the stacking table, wherein the first and/or the second segment feed apparatuses each comprise at least one rotational body which is rotatably mounted about an axis of rotation, which is designed to transport sections via a rotational movement.

It has been shown that by means of the rotational bodies, the conveying speed of the segments can be adapted particularly well to the downstream process steps of stack formation. The adaptability of the conveying speed of the segments achievable in this way can increase the overall production output of the device, which leads to lower production costs.

Furthermore, by conveying the segments by means of the rotational bodies, a relative movement between the contact surface of the rotational body and the segment lying thereon can be significantly reduced or completely avoided. The avoided slippage results in less abrasion and contamination, which in turn improves the quality of the finished stack, which is used, for example, to form an energy cell. The scrap rate can therefore also be reduced.

Furthermore, conveying the segments by means of a rotational body offers the advantage of high flexibility. This means that additional rotational bodies can be added to realize additional functions without much effort. Furthermore, this creates the possibility of generating new production paths on which the segments are conveyed, or of combining existing production paths.

Furthermore, rotational bodies as means of conveyance offer the advantage that the conveying path of the material supply can be designed flexibly; for example, the segments can be fed from any spatial direction, and the conveying paths can still be spatially separated from one another.

Finally, rotational bodies as means of conveyance offer the advantage that segments can be easily removed from the rotational bodies. For example, segments that are damaged or do not meet quality requirements can be easily removed from the production process. The number of faulty stacks can thereby be reduced.

Of course, within a segment feed apparatus, the transport of segments does not have to take place entirely on rotational bodies. It is certainly possible that other means of conveyance may be provided for sections. For example, if it is advantageous for a process step, a segment can be placed on a belt system for processing and later picked up again by a rotational body. This allows the optimal conveying concept to be implemented for each process step.

In accordance with a preferred embodiment, it is proposed that the one rotational body or at least one of the plurality of rotational bodies of the first and/or the second segment feed apparatus conveys segments in a clocked movement.

Within the meaning of this application, a clocked movement is understood to mean the succession of cycles, each of which comprises a rest interval and a movement interval. In the rest interval, the movement speed is significantly reduced in comparison to the movement interval. Within the meaning of this application, a significantly reduced speed means that the maximum speed in the rest interval may be a maximum of 0.5 times the maximum speed in the movement interval, preferably a maximum of 0.2 times and in particular preferably 0.1 times. In accordance with a preferred embodiment of this application, the speed of movement of the segments and/or the endless web in the rest interval is zero or approximately zero. Of course, it is known to a person skilled in the art that a longer duration of the rest interval and a greater degree of speed reduction, for example down to zero, in the rest interval must be compensated by an even higher speed in the movement interval.

By means of the clocked movement, a clocked stacking process can be ensured, which leads to much process reliability. Furthermore, certain processes can be carried out on the clocked moving segments in the rest interval, in particular when at standstill, and other functions can be carried out in the movement interval. For example, it may be advantageous to carry out the process of inspecting a segment in a rest interval and the process of a specific type of processing, for example the process of cleaning, of a segment in the movement interval. Finally, the clocked movement offers the advantage, in particular when the first and second segment feed apparatuses are present, that one of the segment feed apparatuses pauses for one cycle if a segment is missing from the other segment feed apparatus, for example because it has been ejected. This means that it is possible to dispense with rejecting segments that meet quality requirements.

It is further proposed that the first and/or the second segment feed apparatus each comprise a transfer apparatus which is designed to deposit segments on the stacking table, in particular by a back-and-forth movement. The deposit movement is therefore decoupled from the rotational movement of the rotational bodies. By means of the transfer apparatus, a deposit movement can be carried out such that the segments can be deposited in a positionally accurate manner on the stacking table. When it is mentioned below that segments are deposited on the stacking table, this does not necessarily mean depositing a segment directly on the stacking table, but also depositing it on an unfinished stack that is formed on the stacking table.

Preferably, a rotational body of the first and/or the second segment feed apparatus forms a transfer rotational body from which the transfer apparatus of the first and/or the second segment feed apparatus takes a segment. In this way, it can be ensured that the segment can be transported up to just before the stacking table by means of a rotational body and therefore with the advantages described above. Preferably, in addition to a single transfer apparatus of the first and/or the second segment feed apparatus, no further transport means are provided between the transfer rotational body and the stacking table. Preferably, the first and/or the second segment feed apparatus each comprise a plurality of rotational bodies, of which exactly one forms the transfer rotational body, as well as exactly one transfer apparatus.

In accordance with a preferred embodiment, it is proposed that the transfer rotational body of the first and/or the second segment feed apparatus has recesses which enable engagement of an outer contour of the associated transfer apparatus so that the transfer apparatus engages in the recesses of the transfer rotational body when receiving a segment. In this way, the segments can be taken by the transfer rotational body using a combing movement in a way that protects the product.

It is further proposed that the device comprises a first and a second segment feed apparatus, wherein the transfer rotational bodies of the first and the second segment feed apparatus are arranged such that the material web is guided therebetween by means of the material web feed apparatus. In other words: the transfer rotational body of the first segment feed apparatus is arranged on a different side of the material web than the transfer rotational body of the second segment feed apparatus.

By means of this arrangement, the material web can be fed to the stacking table between the two transfer rotational bodies. Furthermore, this allows the material web fed to the stacking table to be supplied with segments on both sides from the two transfer rotational bodies.

Preferably, the stacking table comprises a hold-down apparatus which preferably comprises one or more hold-down fingers, wherein the hold-down apparatus is designed to temporarily fix a segment deposited on the stacking table by the transfer apparatus of the first and/or the second segment feed apparatus. Securing the segments by means of the hold-down apparatus allows the material web to be placed around the segment fixed in this manner without slipping; this allows for reliable formation of the zigzag fold. If the hold-down apparatus is formed by one or more hold-down fingers, the hold-down fingers can be brought into a fixed state and a released state, for example individually or in groups, in particular in pairs. The fixed state is preferably achieved by the corresponding hold-down fingers pressing the segment from above against the rest of the stack. Furthermore, the holding fingers are preferably additionally displaceable in the horizontal direction so that they can be pulled out of the stack to reach the released state when a new layer of the material web and/or a new segment is placed over the segment fixed by them. Preferably, the hold-down fingers have a flattened section so that they can be easily pulled out of the stack. The switching state of the hold-down apparatus is preferably controlled and/or regulated such that after a first segment has been placed on the stacking table, corresponding hold-down fingers of a first group are brought into the fixing position. The material web is then placed around or on the deposited first segment so that another segment can be placed on top of it. This further segment is then preferably fixed by the transfer apparatus and/or with further hold-down fingers of a second group; only when this state is reached are the hold-down fingers of the first group moved from the fixing position to the release position. In a corresponding manner, the hold-down fingers of the second group are then also moved from the fixing position to the release position. Preferably, the hold-down fingers of the hold-down apparatus are divided into two groups. The hold-down finger(s) of the first group are designed to fix a segment of the first type which is fed from a first side of the material web from the stacking table. Furthermore, the hold-down finger(s) of the second group are designed to fix a segment of the second type which is fed from a second side of the material web from the stacking table. Therefore, by alternatingly fixing the segments of the first and second type by means of the hold-down apparatus and by appropriately folding the material web around the just fixed segment, a stack can be formed in which the material web wraps around the segments in a zigzag manner. Furthermore, the alternating fixing has the advantage that the hold-down fingers of the first group are only in contact with the segments that are fed from the first side of the stacking table, and the hold-down fingers of the second group are only in contact with the segments that are fed from the second side of the stacking table. This can prevent particle cross-contamination, which could negatively affect the quality of the stack.

Preferably, the device comprises a first and a second segment feed apparatus, wherein the device is designed to alternatingly deliver a segment of the first segment feed apparatus and the second segment feed apparatus to the stacking table to form the stack. Preferably, a different type of segments is conveyed and fed to the stacking table by the first segment feed apparatus than by the second segment feed apparatus. This can also prevent particle cross-contamination, i.e., contamination with particles of the other type of segment, when feeding segments of different types to the stacking table. If the first segment feed apparatus is used to feed segments of the first type, for example in the form of anode sheets, and the second segment feed apparatus is used to feed segments of the second type, for example in the form of cathode sheets, then segments of the first and second type can be placed alternatingly on the stacking table. Preferably, the material web is a web-shaped separator. The proposed device allows the separator to be placed in a Z-shape around the segments in the form of cathode and anode sheets so that the proposed device can be used in a manufacturing process to form a battery cell. With such an embodiment of the device, corresponding cell stacks can be manufactured at a significantly higher production speed in comparison to the prior art.

It is further proposed that the transfer apparatus of the first and/or the second segment feed apparatus is designed to convey a segment on a curved path, for example on a circular path section, and/or to convey it while changing its spatial alignment. It has been shown that such a movement path, preferably in combination with the change in the spatial alignment of the segment, can achieve a particularly positionally accurate deposition of the segments on the stacking table.

It is further proposed that the first and/or the second segment feed apparatus each comprise a first conveying section, wherein the device is designed to convey an endless segment web, from which the segments are formed, in the first conveying section at a constant or approximately constant conveying speed. Within the meaning of this application, an approximately constant speed of the endless segment web is understood to mean a speed whose minimum and maximum speeds do not deviate from the average conveying speed by more than 20%, preferably by not more than 10% and more preferably by not more than 5%. In this way, an endless segment web can be fed continuously or almost continuously to the stacking process, wherein for example this is provided as a coil with a wound electrode web. Preferably, all webs, i.e., both the endless segment webs and the material web, are provided as coils.

Preferably, the first and/or the second segment feed apparatus each comprise a second conveying section, wherein the device is designed to convey the endless segment web with a clocked movement in the second conveying section. By conveying the endless segment web in a clocked movement in the second conveying section which preferably extends over a plurality of rotational bodies, one can benefit from the aforementioned advantages of a clocked movement. Due to the clocked movement in the second conveying section, the stack can in particular be constructed asymmetrically. For example, an anode sheet can be deposited as the first and last segment of the stack by switching off a so-called cathode cycle in which a cathode is fed to the stacking table.

Preferably, a compensation apparatus, for example comprising a dancer roller, is arranged between the first conveying section and the second conveying section, wherein:
the compensation apparatus is designed to enable a transition between a constant conveying speed and clocked movement. A person skilled in the art understands a dancer roller to be a roller around which the material web is guided, the axis of rotation of which is mounted so that it can be moved and/or pivoted in order to carry out a compensating movement. The dancer roller has proven itself in practice as a reliable component for compensating the different conveying speeds in the first and the second conveying sections.

Preferably, a separating apparatus is provided in the second conveying section, which is designed to divide the endless segment web into segments. In the second conveying section, there are in principle options of carrying out the subdivision in the rest interval or in the movement interval. In practice, separation in the movement interval has proven to be advantageous. The separating apparatus can, for example, be designed to perform a mechanical cut; this can also be done, for example, by means of a knife and/or a counter edge as a cutting means. It has proven advantageous if the endless segment web to be cut is guided on a rotational body in the form of a cutting drum during the cut, and the cut is carried out by a rotating knife. Alternatively, the cutting apparatus may also be designed to perform a thermal cut; in this case, the cutting means may be, for example, a laser.

It is further proposed that in a third conveying section of the first and/or second segment feed apparatus, segments are conveyed with a clocked movement. This means that all processes carried out in the third conveying section can benefit from the clocked movement. Preferably, the third conveying section is arranged downstream from the first and second conveying sections. Therefore, the segments are transferred from the third conveying section of the first and/or second segment feed apparatus to the stacking table.

It is further proposed that the at least one rotational body of the first and/or the second segment feed apparatus is a drum which is designed to hold and convey a segment on its lateral surface, in particular by means of vacuum. This allows the segments to be transported in or on the corresponding transport section on the lateral surface of the drum. The segments can be held, for example, by applying vacuum in or on the transport section and/or by mechanical holding means. The holding force on the rotational bodies is preferably adjustable such that a transfer of a segment to an adjacent rotational body can take place. The transfer of a segment to an adjacent drum preferably takes place in the movement interval. Furthermore, rotational bodies in the form of drums offer the advantage that they can be easily modified, for example to be adapted to the segment to be transported, or to adapt the conveying movement to the requirements of optionally existing functional units of the device. The drums are preferably also arranged and/or their rotation is controlled such that, in the rest phase, sections of a segment are not located on two adjacent drums at the same time.

For example, plungers and/or sliders can be provided in the interior of the rotational body, which are designed to move the transport sections individually radially outwards and/or parallel to the axis of rotation in order to transfer a segment to a neighboring drum.

Alternatively or additionally, at least one drum can be designed as a pitch change drum. Such a pitch change drum can have a plurality of transport sections arranged on the circumference for transporting one segment of the material flow each, wherein the transport sections are movable in the radial direction and/or circumferential direction of the pitch change drum so that the segments are moved from a receiving point to a delivery point from a smaller radius to a larger radius and/or in the circumferential direction. The proposed pitch change drum allows the distance to be increased on a rotating drum itself. The increase in the distance between the segments is caused by the transport sections and their movement, in that the segments held on the transport sections are moved by the transport sections themselves into an alignment at an increased or decreased distance from one another without slippage and friction towards or away from one another.

It is further proposed that the material web feed apparatus comprises a folding apparatus which is designed to place a section of the material web over and/or around the uppermost segment of the stack located on the stacking table by means of a back-and-forth movement. It has been shown that by the back-and-forth movement of the folding apparatus, which is preferably carried out in a horizontal plane, the material web can be efficiently placed around the uppermost segment on the unfinished stack. The back-and-forth movement can be in the form of a linear movement or as a pivoting movement.

Preferably, the folding apparatus comprises a movably mounted pair of rollers through which the material web is guided. The movably mounted pair of rollers allows a section of the material web located above the cell stack to be moved back and forth as described above. A movably mounted pair of rollers is understood to mean that the axes of rotation of both rollers of the pair of rollers can be moved, preferably displaced, such that the position and/or the alignment of the axes of rotation of both rollers changes in the same way. The material web is fixed in a first section by the unfinished stack and in a second section is guided through the movably mounted pair of rollers so that the corresponding fold can be formed around the uppermost segment of the unfinished cell stack by the back-and-forth movement of the movably mounted pair of rollers. The desired Z-fold can be achieved by the back-and-forth movement of the material web and the synchronized alternating addition of segments by the first and second segment feed apparatuses.

It is further proposed that the device is designed to continuously feed the material web by means of the material web feed apparatus to a compensation apparatus, for example comprising a dancer roller, from which the folding apparatus is supplied with the material web. The movably mounted pair of rollers of the folding apparatus, which generates the folding movement, requires, due to its movement, a temporally changing feed speed of the material web per work cycle. This effect can be compensated by the compensation apparatus so that the material web can be fed to the compensation apparatus at a constant speed. Furthermore, sufficient web tension can be maintained within the material web feed apparatus.

It is further proposed that the device comprises a first and a second segment feed apparatus, wherein a folding space is defined by the curved lateral surfaces of the transfer rotational bodies of the first and the second segment feed apparatus as well as by the stacking table, wherein the folding apparatus deflects the material web by utilizing this folding space to carry out a folding movement. Further preferably, the device is additionally designed such that an opening angle is formed by the curved lateral surfaces of the two transfer rotational bodies, preferably arranged opposite one another, of the first and second segment feed apparatuses, wherein the folding apparatus deflects the material web by utilizing this opening angle to perform a folding movement. The invention has recognized that, by means of the transfer rotational bodies of the first and the second segment feed apparatus, the segments can in this way firstly be transported to just before the stacking table and, secondly, the folding space and/or the formed opening angle offers sufficient space for a pivoting movement of the transfer apparatus. And thirdly, the folding space and/or the opening angle creates enough room to move the movably mounted pair of rollers of the folding apparatus back and forth above the stacking table.cb

In accordance with a further preferred embodiment, it is proposed that the first and/or the second segment feed apparatus each comprise at least three rotational bodies, wherein at least three of the rotational bodies of the first and/or the second segment feed apparatuses are arranged in a linear configuration, wherein the linear configuration is defined such that the axes of rotation of all rotational bodies of the linear configuration run in a common plane, wherein preferably all rotational bodies of the linear configuration have the same diameter. Due to the linear arrangement, the arrangement of functional units that interact with the rotational bodies of the linear arrangement can be changed and/or expanded as desired. Such functional units can be, for example, inspecting or cleaning apparatuses.

Preferably, the stacking table is mounted during the stacking process such that movements of the stacking table with a horizontal directional component are prevented, or the stacking table can be moved by a maximum of 2 mm in the horizontal direction to compensate for position errors when depositing segments, more preferably by a maximum of 1 mm, in particular preferably by a maximum of 0.5 mm. By preventing a horizontal movement component of the stacking table, it is achieved that the processes of folding the material web and depositing the segments can be realized solely by the kinematics of the folding apparatus as well as the transfer apparatus of the first and/or second segment feed apparatus. It has been found that this can reduce position errors when depositing the segments and/or the material web. If position errors were to nonetheless occur, these could be prevented by the ability of the stacking table to make minimal movements to compensate for positioning errors.

Preferably, the stacking table is movable in the vertical direction such that the addition of segments and/or material webs takes place at a constant height during stack formation. The stacking table therefore moves downwards during the formation of the stack to ensure addition at a constant height. Depositing the segments and/or the material web at a constant height has the advantage that the positioning accuracy when depositing the segments and/or the material web can be increased. The mobility in the vertical direction also supports the release of the finished stack, for example to a subsequent gripping apparatus with a transport function.

During the stacking on the stacking table, the newly deposited segments is not covered by a transfer apparatus or similar for a short time window so that the deposit position of the newly placed segment can be detected, for example, by a corresponding detection apparatus.

Furthermore, it is preferred if the device is designed to move the stack, after its completion, from the stacking table into a wrapping position and/or into an intermediate position that is provided between the stacking table and the wrapping position, wherein by moving the stack from the stacking table into the wrapping position or into the intermediate position, a material web tail that projects beyond the stack is pulled out of the material web feed apparatus, wherein a separating apparatus is provided which is designed to separate this material web tail from the endless material web of the material web feed apparatus so that the material web tail has a free end, wherein a wrapping apparatus is provided which is designed to wrap the finished stack with the projecting, free material web tail in the wrapping position. As a result, as soon as the stack reaches the wrapping position and the material web has been sufficiently pulled out beyond the stacking position at the same time, for example in the form of the separator web, to form the material web tail, a new stack can be started by depositing a segment, for example in the form of an anode or cathode sheet, on the material web. If the sufficient length of the material web tail is already reached in the intermediate position, the movement in the intermediate position stops briefly so that a separating cut is carried out by means of the separating apparatus. The separating cut is therefore made in the intermediate position. The transport of the stack then continues until the wrapping position is reached. Regardless of whether the separating cut takes place in the wrapping position or in the intermediate position, the stacking process can be continued immediately after a short interruption, which increases the production rate in the manufacture of energy cells, in particular battery cells, for example in the form of Li-ion batteries. The wrapping of the stack with the same, continuous, i.e., one-piece, material web can therefore be carried out during the already started stacking process of the subsequent stack. This not only increases throughput but also allows more processing time to be allocated to wrapping so that higher quality can be achieved.

Preferably, the device comprises a fixing apparatus which is designed to fix the material web tail wrapped around the stack by the wrapping apparatus. Accordingly, the free end of the material web tail can be fixed on the material web tail that is already wrapped around the stack. The fixation can be achieved, for example, by applying an adhesive or a tape, i.e., an adhesive strip that is applied on one or both sides, by the fixing apparatus. The wrapped stack can then be finally fixed. The device can, for example, comprise further processing apparatuses, for example an apparatus which is designed to connect conductor lugs of the segments of the formed stack to one another. Furthermore, the device can also comprise inspection apparatuses for geometrically inspecting the stack, the tape and its position. Finally, apparatuses for weighing, coding and/or labeling the stack can also be provided.

Preferably, the device is designed to form a subsequent stack on the stacking table during the wrapping of the stack by means of the wrapping apparatus and/or during the separation of the material web tail from the remaining material web. In this way, the processes of wrapping and stacking can be parallelized in time so that the overall production speed can be increased.

Preferably, the device comprises a material supply which is designed to supply the first and/or the second segment feed apparatus as well as the material web feed apparatus each with an endless web of the corresponding material which is provided in the wrapped state as a coil. By creating the possibility of providing the material as a coil, an efficient material supply can be ensured. Further preferably, the separate units of the material supply are spatially separated from each other such that cross-contamination can be prevented.

In accordance with a further development, it is proposed that the material supply of the device comprising a first and a second segment feed apparatus comprises separate units so that the first and second segment feed apparatus as well as the material web feed apparatus can each be supplied with continuous webs of different types. For example, the first segment feed apparatus can be supplied with an endless segment web from which anode sheets can be formed by a separation process. Furthermore, for example, the second segment feed apparatus can then be supplied with an endless segment web from which cathode sheets can be formed by a separation process. Furthermore, for example, an endless material web made of a separator material is fed to the material web feed apparatus.

It is further proposed that each of the units comprises a coil holder for an expiring coil and a coil holder for a new coil, wherein a splicing apparatus is provided with which a free end of an expiring coil can be connected to a free end of a new coil. This embodiment allows the webs, i.e., the endless segment web and the material web, to be fed continuously in principle. In other words, the webs can be provided as endless webs by the material supply. The splicing apparatus can, for example, comprise a connecting apparatus with at least one adhesive applicator which is designed to connect an expiring web to a new web.

For example, the expiring web can be connected to the new web end-to-end. This can be achieved, for example, by the splicing apparatus comprising a first jaw and a second jaw which are designed to apply a clamping force to an overlapping section of the expiring web and the new web provided by the feed apparatus. The connecting apparatus further has a cutting apparatus which is designed to cut the expiring web and the new web, which are subjected to a clamping force between the jaws, in a common cut through the overlapping section in order to produce the web end of the expiring web and the web start of the new web. The first jaw is designed to hold the end of the expiring web and the beginning of the new web for application of an adhesive by the adhesive applicator by means of a vacuum when the clamping force of the jaws is released.

An end-to-end splice can also be carried out by means of the following alternative: The splicing apparatus then comprises, for example, at least one adhesive applicator which is designed to connect an expiring web to a new web. Furthermore, the splicing apparatus comprises a first suction jaw for temporarily holding a section of the expiring web by means of vacuum and a second suction jaw for temporarily holding a section of the new web by means of vacuum, wherein the web end of the expiring web and the web start of the new web can be positioned in a desired alignment with respect to one another by means of the first and the second suction jaw so that the web end and the web start can be connected to one another in the desired alignment by means of the at least one adhesive applicator, wherein in the desired alignment, the free end sides of the web end and the web start are arranged one behind the other, i.e., they abut one another.

The splice of the separator web is preferably produced in a section of overlapping separator webs without additives by means of an embossed connection.

Preferably, when carrying out the conveying movement, a web edge control apparatus is provided downstream from the splicing apparatus, which is designed to correct the alignment and/or position of an edge of the corresponding endless web if necessary. The web edge control apparatus is therefore arranged downstream from the splicing apparatus with respect to the conveying movement. By means of the web edge control, correct alignment of one of the web edges or the web center can be ensured. It goes without saying that the control apparatus can comprise a sensor apparatus with which the actual state of the endless web can be detected. This sensor apparatus can, for example, be designed to detect the position and/or alignment of the web edge. Alternatively, it would however also be possible to record the center line of the endless web since this would allow conclusions about the position and/or alignment of the web edge. Based on the data acquired in this manner, the alignment and/or arrangement of the web edge can be accordingly corrected by means of a correction unit.

It is further proposed that the first and/or second segment feed apparatus comprise one or more of the following functional units: an inspection apparatus that is designed to inspect a segment; a detection apparatus designed to detect the presence of a segment, to detect a position and/or to detect an alignment of a segment on a rotational body; a cleaning apparatus that is designed to clean a segment; and/or an ejection apparatus that is designed to eject a segment from the production process. With these functional units, the segments can be inspected, cleaned and/or ejected on the transport route to the stacking table.

It is further proposed that a functional unit comprises two components, wherein the two components are assigned to different rotational bodies of a segment feed apparatus, wherein the two components of a functional unit are assigned to mutually adjacent rotational bodies, or wherein the two components of a functional unit are assigned to two rotational bodies between which an even number of further rotational bodies are arranged. Neighboring rotational bodies transfer segments such that the free upper side of the releasing rotational body is the lower side resting on the receiving rotational body. Therefore, by transferring from a releasing to a receiving rotational body, the segment is rotated once by 180° in relation to its contact surface. Consequently, by means of the proposed arrangement of two components that are assigned to a functional unit, the corresponding function, in particular cleaning and/or inspecting, can be performed on the top and bottom sides of a segment. The same effect is achieved if an even number of additional rotational bodies are arranged between the rotational bodies.

Preferably, the functional units are assigned to the third conveying section. This allows the functional units to benefit from the clocked movement.

Preferably, the rotational bodies are arranged such that a stationary, rotatingly mounted rotational body is followed by a displaceably mounted rotational body; the displacement preferably occurs in a direction orthogonal to a plane spanned by the axes of rotation of the two respectively adjacent, stationary rotational bodies. The movable bearing allows the transfer distances between adjacent rotational bodies to be adjusted, for example to adapt them to a change in the thickness of the segments. In this case, the transfer rotational body, from which the segments are transferred to the stacking table by means of the transfer apparatus, forms a stationary rotating rotational body. This can increase process reliability.

Preferably, the segments are fed to the stacking table in the form of anode sheets on the same side of the material web as the stacks are removed from the stacking table. This is advantageous because the first and last segment of the stack is preferably an anode sheet. This means that the folding apparatus must move the material web away from the side from which the segments in the form of the anode sheets are fed by means of the segment feed apparatus. Therefore, the stack can only be gripped from the side, for example by a clamping apparatus of the conveyor carriage, from which the last segment in the form of the anode sheet is fed. In other words: The stack can only be grasped from the side on which the folding apparatus, in particular a corresponding pair of rollers of the folding apparatus for guiding the material web, is not currently located.

In accordance with a second aspect of this application, to achieve the object, a method is proposed for the energy cell manufacturing industry for forming a stack that comprises a plurality of segments and a material web, wherein the material web is folded in a zigzag manner and the segments are deposited on the material web such that in the stack, the segments are arranged in the folds of the material web, wherein a first and/or a second segment feed apparatus is used to convey sections to a stacking position, wherein the first and/or the second segment feed apparatus each comprise at least one rotational body which is rotatably mounted about an axis of rotation and is designed to convey sections via a rotational movement.

It is further proposed that when carrying out the method, an endless segment web is fed to each of the first and/or the second segment feed apparatuses, wherein the endless segment web is conveyed in a first conveying section at a constant conveying speed, wherein the endless segment web is conveyed in a clocked manner in a second conveying section and is divided into segments, and wherein the segments are conveyed in a clocked manner in a third conveying section.

Preferably, the method comprises the following stacking steps: In stacking step a), a section of the material web is placed over the stacking table or onto a segment lying on the stacking table. Subsequently, in stacking step b), a segment of the first type is deposited on the section of the material web placed over the stacking table. Subsequently, in stacking step c), the material web is placed on the stacking table, forming a fold around the deposited segment. Finally, in stacking step d), a segment of the second type is deposited on the section of the material web that lies on the stacking table.

To form a complete stack, stacking steps b) and d) are carried out alternatingly with stacking step c) interposed; this process is then repeated several times.

It is further proposed that the material web is a separator, wherein the segment of the first type is an anode sheet and wherein the segment of the second type is a cathode sheet.

Preferably, a segment of the first type is deposited as the first segment of the stack by means of method step b), and a segment of the first type is deposited as the last segment of the stack by means of method step b). Therefore, by omitting method step d), which actually involves adding a segment of the second type, a stack can be formed whose first and last segments are segments of the first type. It is preferred that the segments of the first type are anode sheets. In this way, an asymmetric stack can be formed whose first and last electrode is an anode sheet.

It is further proposed that, after the formation of the stack, a section of the material web projects beyond the formed stack so that a material web tail with a free end is formed, wherein the formed stack is wrapped by means of the material web tail.

Preferably, the formation of a stack by folding the material web takes place simultaneously with the wrapping or with the separation of the material web tail of another stack at different positions.

Preferably, the proposed method is carried out using the device in accordance with the first aspect of this application, optionally taking into account the preferred further developments explained above.

With regard to the technical effects and advantages associated with the proposed method, reference is made to the previous explanations in connection with the device.

In accordance with a further aspect of this application, the object is achieved by a unit for the energy cell manufacturing industry for forming a stack that has a plurality of segments and a material web, wherein the device is configured and designed to fold the material web in a zigzag manner and to deposit the segments on the material web such that, in the stack, the segments are arranged in the folds of the material web, wherein the device has the following components: a stacking table on which the stack is formed; a material web feed apparatus that is configured and designed to convey the material web to the stacking table; a first segment feed apparatus that is configured and designed to transport sections to the stacking table; and/or a second segment feed apparatus which is configured and designed to transport sections to the stacking table, wherein the first segment feed apparatus has at least one rotational body rotatably mounted about an axis of rotation and which is configured and designed to transport sections via a rotational movement and/or the second segment feed apparatus has at least one rotational body rotatably mounted about an axis of rotation and which is configured and designed to transport sections via a rotational movement.

One rotational body or a plurality of rotational bodies of the first segment feed apparatus can have a circumferential surface and can be configured and designed to receive one segment or a plurality of segments adjacent to its circumferential surface.

One rotational body or a plurality of rotational bodies of the second segment feed apparatus can have a circumferential surface and can be configured and designed to receive one segment or a plurality of segments adjacent to its circumferential surface.

The circumferential surface of at least one rotational body of the first segment feed apparatus can extend in the circumferential direction, preferably in a curved shape.

The circumferential surface of at least one rotational body of the second segment feed apparatus can extend in the circumferential direction, preferably in a curved shape.

Rotational bodies on which individual segments are transported can be designed as drums, the lateral surface of which has a plurality of transport sections on which the segments can be conveyed.

One rotational body of a plurality of rotational bodies of the first segment feed apparatus can be designed as a transfer rotational body.

One rotational body of a plurality of rotational bodies of the second segment feed apparatus can be designed as a transfer rotational body.

The first segment feed apparatus can have a transfer apparatus which is configured and designed to deposit segments on the stacking table.

The second segment feed apparatus may comprise a transfer apparatus which is configured and designed to deposit segments on the stacking table.

A rotational body of the first segment feed apparatus can form a transfer rotational body from which a transfer apparatus of the first segment feed apparatus takes a segment.

A rotational body of the second segment feed apparatus can form a transfer rotational body from which a transfer apparatus of the second segment feed apparatus takes a segment.

The first segment feed apparatus can have a transfer apparatus in the form of a pivoting lever SH that is rotatably mounted about an axis of rotation.

A transfer apparatus of the first segment feed apparatus can have a vacuum holding system UHS for holding a segment.

The second segment feed apparatus can have a transfer apparatus in the form of a pivoting lever SH that is rotatably mounted about an axis of rotation.

A transfer apparatus of the second segment feed apparatus can have a vacuum holding system UHS for holding a segment.

A vacuum holding system UHS can have a vacuum supply line UHSL which is fluidically connected to the transfer apparatus.

A vacuum holding system UHS can have a vacuum control station UHSS which controls the application of the vacuum to the transfer apparatus, in particular switches the vacuum on or off.

A vacuum holding system UHS can have one vacuum channel or a plurality of vacuum channels that extends into and/or through the transfer apparatus and are preferably provided with openings that are arranged on an outer boundary surface and/or in the region of an outer boundary surface of the transfer apparatus in order to hold a segment by means of a vacuum.

A transfer apparatus in the form of a pivoting lever SH can be designed as a pivoting lever SH which has a bearing end SHLE and a free end SHFE. At the bearing end SHFE, the pivoting lever SH can be rotatably mounted about an axis of rotation. The bearing end SHFE of the pivoting lever SH can have a bearing shaft SHLA for bearing the pivoting lever SH about the axis of rotation and for rotating or pivoting the pivoting lever SH about the axis of rotation, preferably by means of an actuator, in particular a motor. One vacuum channel or a plurality of vacuum channels UHSK-LA can be arranged in the bearing shaft SHLA. The bearing shaft SHLA can have a connecting piece for connecting one vacuum channel or a plurality of vacuum channels UHSK-LA to a vacuum supply line UHSL.

A plurality of tines ZK can extend in the form of a fork from the bearing end SHFE of the pivoting lever SH to the free end SHFE of the pivoting lever SH. The tines can be the same length or different lengths. Preferably, tines lying to the outside are shorter than tines lying to the inside. The tines ZK can form a convexly curved support surface TF for a segment, in particular in the direction from the bearing end SHLE of the pivoting lever towards the free end SHFE of the pivoting lever. The convex curvature of the support surface can then be seen, for example, in a sectional plane that is aligned orthogonally to the axis of rotation of the pivoting lever SH and runs through the support surface. The tines ZK can have flattened boundary surfaces to form the support surface TF, preferably designed such that a segment lies flat against a flattened boundary surface, for example against a flat boundary surface, at least in portions of the segment. On the side opposite the support surface TF, the tines can be concave in the direction from the bearing end SHLE of the pivoting lever to the free end SHFE of the pivoting lever. The concave curvature of the side opposite the support surface TF can then be seen, for example, in a sectional plane that is aligned orthogonally to the axis of rotation of the pivoting lever SH and runs through the side opposite the support surface TF.

The distance between the tines ZK of the pivoting lever SH can be adapted to recesses of a transfer rotational body, in particular such that the tines ZK of the pivoting lever SH can be moved with play relative to recesses of the transfer rotational body.

A tine ZK or a plurality of tines ZK can have one vacuum channel or a plurality of vacuum channels UHSK-ZI, which extend into and/or through the tine ZK and are preferably provided with openings which are arranged on an outer boundary surface and/or in the region of an outer boundary surface of the tine ZK, in particular on or in a support surface TF, in order to hold a segment by means of vacuum. A vacuum channel UHSH-ZI of a tine ZK can be connected to a vacuum channel UHSK-LA of the bearing shaft SHLA of the pivoting lever. A vacuum channel UHSH-ZI of a tine ZK can be connected to a plurality of vacuum channels UHSK-LA of the bearing shaft SHLA of the pivoting lever. A vacuum channel UHSK-LA of the bearing shaft SHLA of the pivoting lever can be connected to a vacuum channel UHSH-ZI of a tine ZK. A vacuum channel UHSK-LA of the bearing shaft SHLA of the pivoting lever can be connected to a plurality of vacuum channels UHSH-ZI of a tine ZK or to a plurality of vacuum channels UHSH-ZI of a plurality of tines ZK.

A transfer rotational body may have vacuum channels ÜKK that extend into and/or through the transfer rotational body and are preferably provided with openings that are arranged on an outer boundary surface and/or in the region of an outer boundary surface of the transfer rotational body in order to hold a segment by means of vacuum.

A transfer of a segment from a transfer rotational body to a transfer apparatus can be carried out with a gradual switching on and off of the vacuum supply in vacuum channels ÜKK of the transfer rotational body and the vacuum supply in vacuum channels UHSK of the transfer apparatus, in particular the vacuum supply in the vacuum channel UHSK-LA or vacuum channels UHSK-LA of the bearing shaft SHLA of a pivoting lever and in the vacuum channel UHSK-ZI or the vacuum channels UHSK-ZI of the tine ZK or the tines ZK of a pivoting lever.

When a segment is transferred from a transfer rotational body to a transfer apparatus, a vacuum is applied to the vacuum channels UHSK of the transfer apparatus at a time A. At the vacuum channels ÜKK of the transfer rotational body, which hold the segment to be transferred, the applied vacuum is advantageously maintained beyond the time A for a time period TX, and only after the expiration of the time period TX is a vacuum supply to the vacuum channels ÜKK of the transfer rotational body 41, 42 switched off. During the time period TX, the segment 3 can be held by means of a vacuum acting via the openings of the vacuum channels ÜKK of the transfer rotational body and a vacuum acting via the openings of the vacuum channels UHSK of the transfer apparatus.

A transfer apparatus can be configured and designed to be externally actuated, in particular by means of an actuator, further in particular by means of a motor, such that a segment can be withdrawn from the transfer rotational body counter to a holding force exerted on the segment by a transfer rotational body.

When a segment is transferred from a transfer rotational body to a pivoting lever SH, a vacuum is preferably applied at a time A to the vacuum channel UHSK-LA or to the vacuum channels UHSK-LA of the bearing shaft SHLA and to the vacuum channel UHSK-ZI or to the vacuum channels UHSK-ZI of the tine ZK or the tines ZK of the pivoting lever SH. At the vacuum channels ÜKK of the transfer rotational body, which hold the segment to be transferred, the applied vacuum is advantageously maintained beyond the time A for a time period TX, and only after the expiration of the time period TX is a vacuum supply to the vacuum channels ÜKK of the transfer rotational body switched off. During the time period TX, the segment can be held by means of a vacuum acting via the openings of the vacuum channels ÜKK of the transfer rotational body and via the openings of the vacuum channel UHSK-ZI or via the openings of the vacuum channels UHSK-ZI of the tine ZK or the tine ZK of the pivoting lever SH. A pivoting lever SH can be configured and designed to be externally actuated, in particular by means of an actuator, further in particular by means of a motor, such that a segment can be withdrawn from the transfer rotational body counter to a holding force exerted on the segment by a transfer rotational body.

A convexly curved support surface TF of a pivoting lever SH for a segment, which can be formed in particular by tines ZK and extends in particular in the direction from a bearing end SHLE of the pivoting lever to a free end SHFE of the pivoting lever SH, can have a radius of curvature which corresponds to the radius of a transfer rotational body, in particular corresponds to the radius of a transfer rotational body or does not deviate from the radius of the transfer rotational body by more than 40%, preferably does not deviate by more than 20%, particularly preferably does not deviate by more than 10%.

The material web feed apparatus can have a folding apparatus. The folding apparatus can be configured and designed to place a section of the material web over and/or around the uppermost segment of the stack located on the stacking table by means of a back-and-forth movement. The back-and-forth movement can be in the form of a linear movement or as a pivoting movement. The folding apparatus can have a movably mounted pair of rollers through which the material web is guided. The material web can be guided continuously between the rollers of the movable pair of rollers. The movable pair of rollers can be provided so that they can move in an arc over the stacking table.

The invention is explained below using preferred embodiments with reference to the accompanying figures, in which:

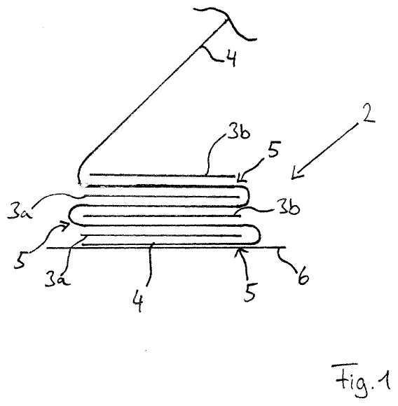

FIG. 1 is a schematic sectional view of a stack with a Z-fold;

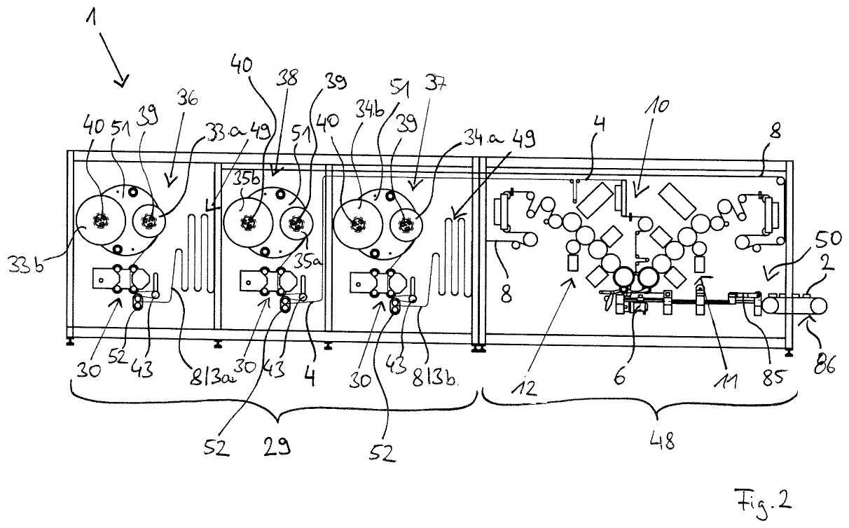

FIG. 2 is a schematic side view of a device;

FIG. 3 is a detailed view of a first unit of a material supply;

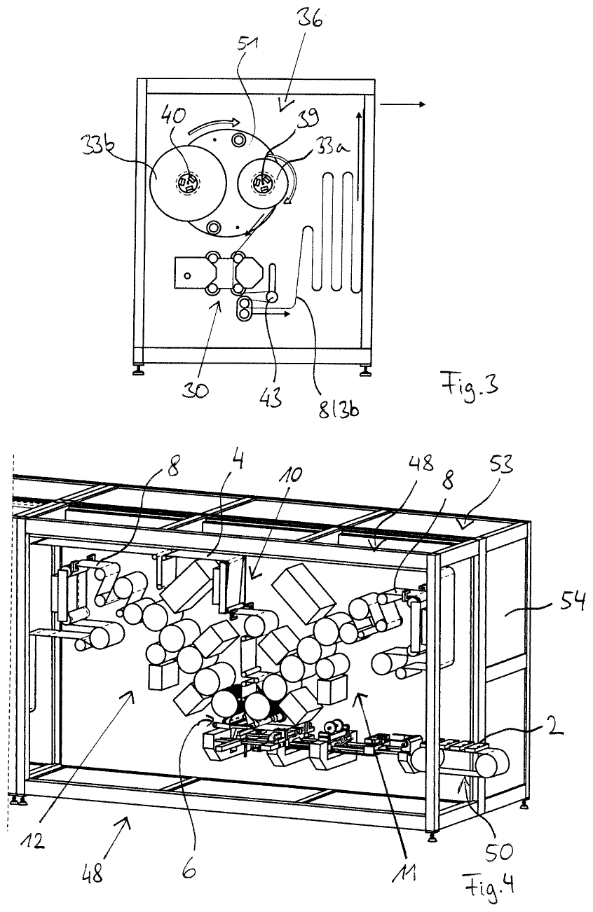

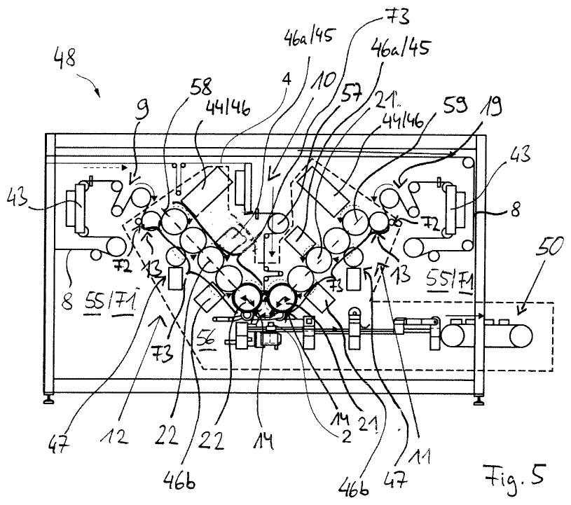

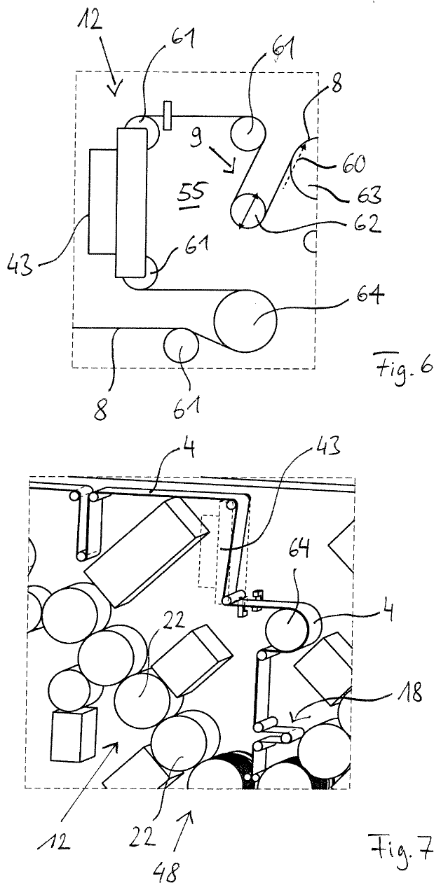

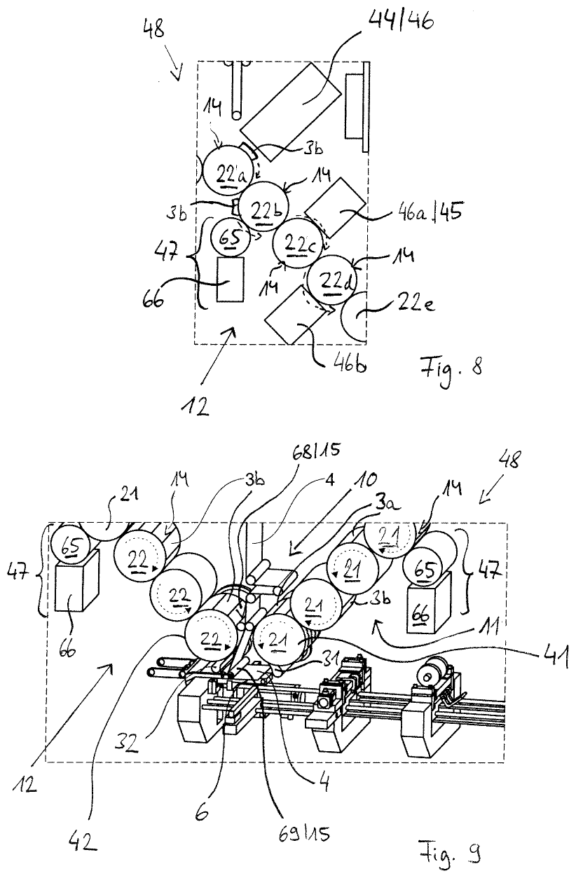

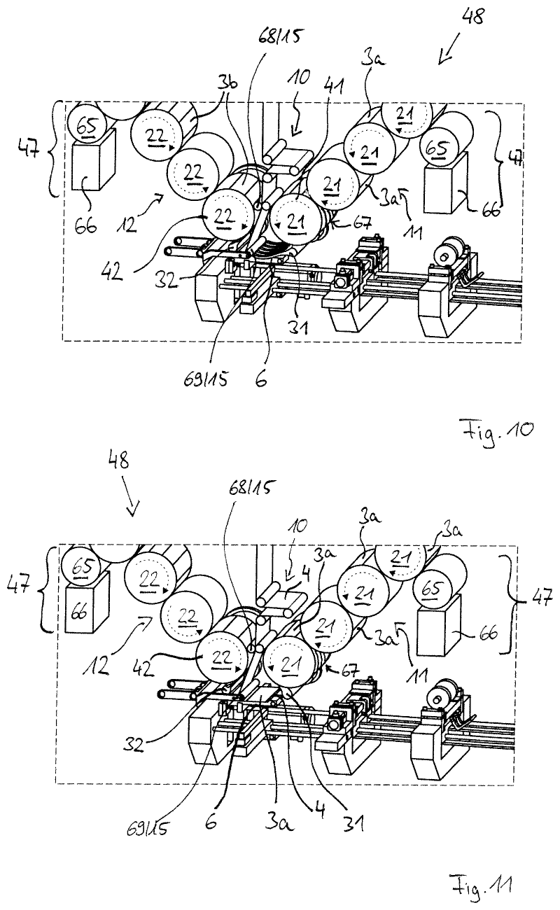

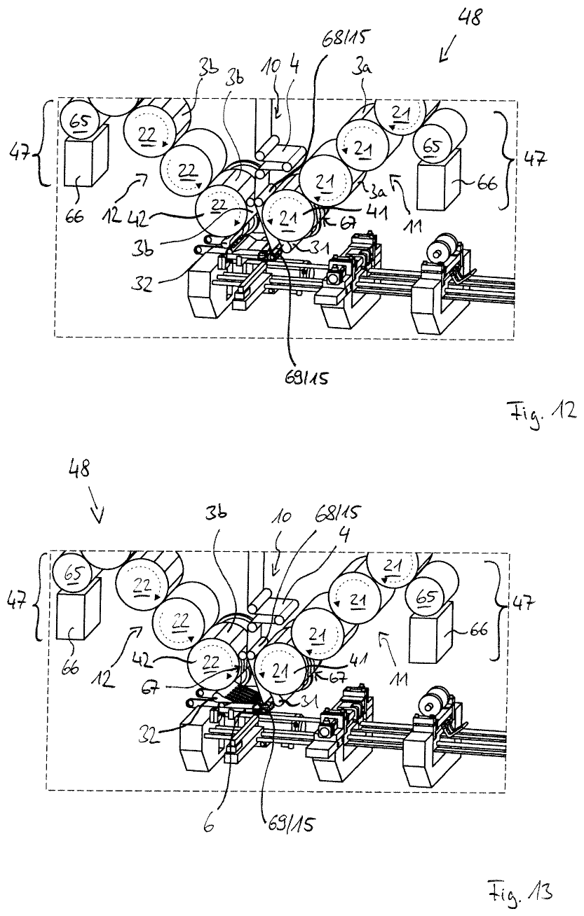

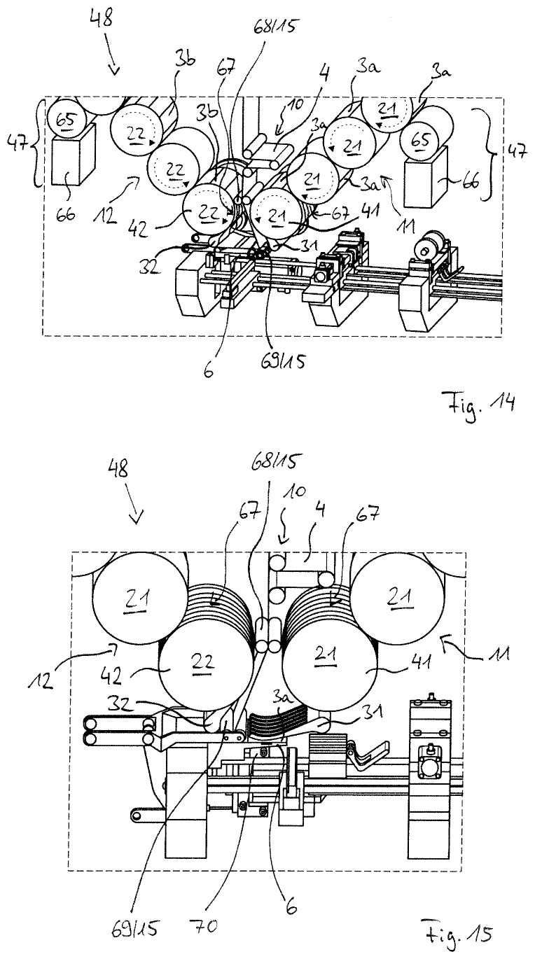

FIG. 4 is a perspective view of a stacking system;

FIG. 5 is a side view of a stacking system;

FIG. 6 is a compensation apparatus of a segment feed apparatus;

FIG. 7 is a compensation apparatus of a material web feed apparatus;

FIG. 8 is a segment feed apparatus with functional units;

FIGS. 9 to 27 are various manufacturing steps for manufacturing a finished and wrapped stack; and

FIG. 28 is a schematic representation of a method for forming a stack.

FIG. 1 shows a schematic representation of an unfinished stack 2 in the form of a cell stack with a material web 4 which is placed in a Z-shape around segments of the first type 3a and segments of the second type 3b.

The stack 2 is formed on a stacking table 6, to which reference will be made below. As shown, the material web 4 lies directly on the stacking table 6. Starting from the stacking table 6, a segment of the first type 3a in the form of an anode sheet then follows. The material web 4 wraps around this segment 3a, forming a fold 5. This is followed by a segment of the second type 3b in the form of a cathode sheet, around which the material web 4 is again wrapped, forming another fold 5. This type of stacking is then repeated several times until stack 2 is completed and the material web is wrapped in a zigzag manner around segments 3a and 3b. As the last segment 3, a segment of the first type 3a, i.e., an anode sheet, is usually deposited on the stack 2.

It should also be noted that the fold edge of the folds 5 does not necessarily have to be sharply peaked. Alternatively, the fold edges can also have a radius so that the material web 4 is placed around the edge of the segments 3a and 3b, forming a bending radius.

FIG. 2 shows a schematic side view of a device 1 for forming a stack 2 comprising a material supply 29 on a left side and a stacking system 48 on the right side.

The material supply 29 comprises three units 36, 37 and 38 which are spatially separated from each other. These three units 36, 37 and 38 can be arranged next to each other as shown in FIG. 2, although it is also possible in principle to arrange them one above the other (not shown). The material provided by the units 36, 37 and 38 is guided as an endless web in separate channels (not shown) to the stacking system 48. The channels can be formed, for example, by dividing plates. The interior spaces of units 36, 37 and 38 are also spatially separated from each other, preferably even hermetically separated from each other. By spatially separating the units 36, 37 and 38 and the corresponding channels from each other, cross-contamination between them can be avoided.

The first unit 36 provides an endless segment web 8 from which segments of the first type 3a, in this case anode sheets, can be formed by separating them in the transverse direction. The endless segment web 8 is formed starting from a coil 33. When an expiring coil 33a, which is rotatably mounted on a coil holder 39, is nearing the end, it can be connected by means of a splicing apparatus 30 to the end of a new coil 33b which is rotatably mounted on a coil holder 40. In this way, an endless segment web 8 can be formed, and the stacking system 48 can be supplied thereby.

Furthermore, the first unit 36 comprises a material storage 49 in the form of a system of dancer rollers in order to compensate for any delays during splicing. Furthermore, the system of dancer rollers serves the purpose of being able to easily change the production speed during a start or stop process. The material storage 49 is therefore a buffer for the corresponding web. By means of the material storage 49, the unwrapping speed of the coil 33a currently expiring and the machine speed of the subsequent stacking system 48 can be adapted to one another. In particular, if the coils 33a and 33b are very large, i.e., have a large mass, they can only be moved dynamically with a delay due to their mass inertia. In particular, such delays are compensated by the mass storage 49.

The second unit 37 of the material supply 29 is constructed analogously to the first unit 36. However, an endless segment web 8 is provided there, from which segments of the second type 3b, in this case cathode sheets, can be formed by being separate in the transverse direction.

A third unit 38 of the material supply 29 is provided between the first and second units 36 and 37. By means of the third unit 38, the material web 4 is also provided in the form of an endless web. The structure of the unit 39 substantially corresponds to the structure of the first and second units 36 and 37, but it does not comprise a material storage 49; however, it may also include a material storage (not shown) that is significantly smaller than the material storage 49 of the first and second units 36 and 37. Furthermore, a difference from the first and second units 36 and 37 is that the third unit 38 provides a material web 4 in the form of a separator.

Furthermore, each of the units 36 to 38 comprises a web edge control apparatus 43 with which the position and/or alignment of a web edge can be regulated.

Furthermore, FIG. 2 shows that each of the units 36, 37 and 38 comprises a traction roller 52 with which the web guided over it can be conveyed. Maintaining a predefined web tension is in particular important for the reliable functioning of the web edge control apparatus 43 arranged directly adjacent to the traction roller 52. In the exemplary embodiment shown here, the traction roller 52 is arranged downstream from the web edge control apparatus 43 with respect to the conveying movement. The respective traction roller 52 therefore ensures that the apparatus following the completion of the conveying movement can also be reliably supplied with the web. In the first and second units 36 and 37, the following apparatuses are the material storage units 49. The third unit 38 does not itself comprise a material storage 49.

Therefore, by means of the units 36, 37 and 38, the endless segment webs 8 and the material web 4 are fed to the stacking system 48 as endless webs.

By means of a first segment feed apparatus 11, the endless segment web 8, from which the segments of the first type 3a in the form of the anode sheets are formed, is fed to the stacking table 6 from the right. By means of a second segment web feed apparatus 12, the endless segment web 8, from which the segments of the second type 3b in the form of the cathode sheets are formed, is fed to the stacking table 6 from the left. Finally, a material web feed apparatus 10 is provided as a component of the stacking system 48, with which the material web 4 is fed to the stacking table 6. In this way, all materials required to form the stack 2 are provided on the stacking table 6. The removal from the stacking table 6 then takes place to the right.

Furthermore, it can be seen in FIG. 2 that the device 1 is substantially designed as a drum machine, i.e., the webs and segments 3 are substantially transported on drums. In the embodiment shown here, the transported segments 3 are held on the drums by the effect of a vacuum. In principle, however, it is also possible to hold the segments 3 to the drums by mechanical holding elements (not shown).

In the embodiment in accordance with FIG. 2, the product flow from the material supply 29 to the stacking system 48 is provided from left to right. This allows a longer but flatter embodiment of the device 1. The webs are therefore fed endlessly from the left to the stacking system 48 by the material supply 29.

The material supply 29 and the stacking system 48 have a modular design. In principle, it is accordingly also possible to arrange the material supply 29 completely above or below the stacking system 48 (not shown). For example, a separate logistics level can be created above or below the stacking system 48, in which new material, preferably in the form of coils 33, 34 and 35, is provided to the material supply 29 and used material, for example empty coils 33, 34, 35, can be removed. The logistics level offers the advantage that crossing paths can be prevented.

Furthermore, it is also possible in principle to arrange the units 36, 37 and 38 on different sides of the stacking system 48 in order to also accordingly feed the corresponding endless webs from different sides (also not shown).

The stacks 2 formed by the stacking system 48 are removed by a discharge apparatus 50 after the completion of further processing steps which are also carried out by components of the stacking system 48.

FIG. 3 shows a detailed view of the first unit 36 of the material supply 29, which is already shown in FIG. 2. A turntable 51 is provided on which the two coil holders 39, 40 are arranged. In this exemplary embodiment, the coil 33a of the expiring segment web, which has already been largely unrolled, is arranged on the coil holder 39. For the production of an endless segment web 8 by the splicing apparatus 30, a new coil 33b with a new segment web is already placed on the coil holder 40. The segment web of the new coil 33b can therefore be connected to the expiring segment web of the expiring coil 33a by the splicing apparatus 30. After the connection, the remainder of the coil 33a with the expiring segment web can be removed from the turntable 51. The coil 33b with the new segment web, which is placed on the coil holder 40, can rotate with the turntable 51 to the previous position of the coil holder 39. After connecting with the expiring segment web, the new segment web itself becomes the expiring segment web.

In this way, an endless segment web 8 can be provided to the stacking system 48. This operating principle is also applied to units 37 and 38.

The splicing apparatus 30 shown in FIG. 3 is designed to butt-join the end of a segment web of the expiring coil 33a with the end of the segment web of the new coil 33b. The two ends butting against each other can be connected to each other, for example, by applying an adhesive, for example in the form of a tape (i.e., an adhesive strip). This type of splicing apparatus 30 is also used in the second unit 37 of the material supply 29 (see FIG. 2).

The splicing apparatus 30 of the third unit 38 (see FIG. 2) is designed to connect the free end of the expiring material web 4 of the expiring coil 35a to the free end of the material web 4 of the new coil 35b by embossing. In so doing, the free ends to be connected are first arranged overlapping and then connected to each other under pressure using a stamping tool; no additional material, such as adhesive, is required.

FIG. 4 shows a perspective view of the stacking system 48. It is indicated in the drawing that behind the stacking system 48 within a housing 54, yet another stacking system 53 is provided so that both stacking systems 48 and 53 can be operated in parallel. The stacking system 48 is also located within a housing 54 to avoid contaminants, but this is shown incompletely in FIG. 4.

FIG. 5 shows a side view of a stacking system 48 which is divided by a dashed line into a first region 55 in which the material is conveyed at a constant conveying speed, and a second region 56, in which the material is conveyed in a clocked movement.

In principle, however, it is also possible to convey the material in the first region 55 at an approximately constant conveying speed instead of at a constant conveying speed, i.e., at a speed whose minimum and maximum speed deviates by no more than 20% from the average conveying speed.

The clocked movement in the second region 56 is characterized in that several cycles are lined up one after the other, each of which comprises a rest interval and a movement interval. For example, a cycle can comprise two or more rest intervals. In the rest interval, the movement speed of the material is equal to zero, while in the movement interval, the movement speed of the material is not equal to zero. In principle, however, embodiments are also possible in which a movement takes place in the rest interval at a speed that is considerably reduced in comparison to the movement interval. In this embodiment, the speed is preferably constant or approximately constant in a sub-interval of the movement interval.

The first and second segment feed apparatuses 11 and 12 each comprise at least one separating apparatus 13 with which the endless segment webs 8 can be severed in the transverse direction so that individual segments 3 arise. In this exemplary embodiment, the separating apparatus 13 comprises a cutting drum and a rotatably driven knife shaft with at least one knife. In this embodiment, the cut occurs in the movement interval. As an alternative to mechanical cutting with a knife and/or counter edge in a shear cut, the cut can also be done thermally by laser. In contrast to mechanical cutting, thermal cutting is carried out in a rest interval, i.e., at a standstill. In principle, thermal cutting can also be carried out during movement intervals.

Each of the segment feed apparatuses 11 and 12 comprises three conveying sections F1, F2 and F3. In the first conveying section F1, the endless segment web 8 is conveyed at a constant conveying speed. In the second conveying section F2, the endless segment web 8 is conveyed in a clocked movement. In this second conveying section F2, the endless segment web 8 is separated into separate segments 3. Consequently, in a third conveying section F3 following the second conveying section F2, the segments 3 are conveyed in a clocked movement.

The first segment feed apparatus 11 comprises a plurality of rotational bodies 21 of which only two are provided with the corresponding reference signs for greater clarity. The second segment feed apparatus 12 also comprises a plurality of rotational bodies 22 of which only two are also provided with a reference sign. Finally, the material web feed apparatus 4 also comprises a plurality of rotational bodies 57 of which only one is provided with a reference sign.

All rotational bodies 21 and 22 on which individual segments 3 are transported are designed as drums, the lateral surfaces 14 of which each have a plurality of transport sections on which the segments 3 can be conveyed.

All rotational bodies of the first and second segment feed apparatuses 11, 12 located in the second region 56 are driven in a clocked movement so that the segments 3 are also conveyed with a clocked movement.

Furthermore, it can be seen that five rotational bodies 21, 22 of the first and second segment feed apparatuses 11 and 12 are arranged in a linear arrangement, which is distinguished in that the axes of rotation of the corresponding rotational bodies 21, 22 are located in a plane 58, 59.

In order to be able to realize the transition between the first region 55 with continuous conveying movement and the second region 56 with the clocked movement, FIG. 5 shows a compensating apparatus 19 of the first segment feed apparatus 11 and a compensation apparatus 9 of the second segment feed apparatus 12. With regard to the conveying movement, a web edge control apparatus 43 is connected upstream from the compensation apparatuses 9 and 19.

The transition region between the first and second regions 55, 56 of the second segment feed apparatus 12 is shown in detail in FIG. 6. The endless segment web 8 is guided over deflection rollers 61 to the belt edge control apparatus 43. Furthermore, a traction roller 64 is provided, which serves to transport the endless segment web 8 and, in cooperation with a roller 63, ensures suitable web tension as well as web control; this is the prerequisite for fold-free transport and for the functioning of the web edge or web center control. From there, the endless segment web 8 is then fed to the compensation apparatus 9 which comprises a dancer roller 62. In this exemplary embodiment, the axis of rotation of the dancer roller 62 can perform a linear back-and-forth movement and therefore perform a compensating movement that enables a transition from a constant conveying movement of the endless segment web 8 to a clocked movement 60 of the endless segment web 8. Alternatively, the back-and-forth movement can also be performed by swinging. The movement only needs to be adjusted such that it can compensate for the supply of the endless segment web 8 at a continuous conveying speed and its clocked delivery without a change in the web tension or with a minimal change in the web tension. In accordance with a further optional measure, the slippage between the endless segment web 8 and the dancer roller 62 can be avoided by an air cushion. The dancer roller 62 is moved in cycles; the web tension can therefore be kept constant. The dancer roller 62 can also be contoured so that the coefficient of friction between the dancer roller 62 and the endless segment web 8 is as large as possible; the compensating movement can be thereby supported or reduced. The dancer roller 62 can optionally be actively driven in its rotational movement in order to avoid slippage between the dancer roller 62 and the endless segment web 8. In each cycle, the dancer roller 62 is accelerated to a conveying speed and then braked to a standstill. Due to this acceleration of the dancer roller 62, it must be designed such that its mass moment of inertia is as low as possible; accordingly, the dancer roller 62 must be designed as light as possible. Therefore, the endless segment web 8 can be conveyed on the roller 63 in a clocked movement.

In a corresponding manner, the transition from the first region 55 to the second region 56 is implemented in the first segment feed apparatus 11.

It is therefore self-evident that the first segment feed apparatus 11 also comprises a corresponding compensating apparatus 19, the structure of which corresponds to that of the compensation apparatus 9. In this way, segments of the first type 3a in the form of anode sheets and segments of the second type 3b in the form of cathode sheets can be inserted alternatingly into the zigzag-folded material web 4 in a clocked movement.

FIG. 7 shows a compensation apparatus 18, which is part of the material web feed apparatus 10. The compensation apparatus 18 allows the folding movement, which is clocked by means of a folding apparatus 15 (see FIG. 9), which requires swinging a section of the material web 4. With regard to the structure of the compensating apparatus 18 of the material web feed apparatus 10, reference is made to the structure of the compensation apparatuses 19 and 9 of the first and second segment feed apparatuses 11 and 12. Furthermore, the material web feed apparatus 10 comprises a web edge control apparatus 43 which is arranged upstream from the compensation apparatus 18 with respect to the conveying direction of the material web 4. On the conveying path of the material web 4, a traction roller 64 is provided between the web edge control apparatus 43 and the compensation apparatus 18.

FIG. 8 shows, with reference to the second segment feed apparatus 12, how functional units can be arranged along the transport path defined by the rotational bodies 22a to 22d. These statements apply equally to the first segment feed apparatus 11.

In FIG. 8, segments of the second type 3a are transported in so-called transport sections on the lateral surfaces 14 of the rotational bodies 22 from top left to bottom right. As an example, two segments of the second type 3b are drawn in FIG. 8, and their conveying movement is indicated by dashed lines.

A segment 3b held on the rotational body 22a is guided in a clocked movement past an inspection apparatus 44, a cleaning apparatus 46, an ejection apparatus 47, a detection apparatus 45 and a further cleaning apparatus 46a, 46b which comprises two components.

The inspection apparatus 44 is designed to inspect a segment 3. In this exemplary embodiment, the inspection apparatus 44 is designed to perform an optical measurement, so that it has an image recording apparatus. Furthermore, a one-sided cleaning apparatus 46 is upstream from the inspection apparatus 44, with which the segment 3b to be inspected can be freed of contaminants in advance. The cleaning apparatus 46 can, for example, be designed to clean cutting edges. This ensures that contaminants do not affect the result of the optical inspection. The cleaning and inspection takes place at a rest interval. By means of the inspection apparatus 44, one-sided checks of the segments 3 can be carried out, for example a geometric measurement of outer contour edges.

The cleaning apparatus 46 can achieve the cleaning effect, for example, by means of a brush, compressed air, a rotating nozzle or by ionization. The contaminants removed during cleaning, such as dust, can be collected by a collecting and/or suction device and therefore removed from the process.

By means of the ejection apparatus 47, segments 3b can be ejected from the production process. For this purpose, the ejection apparatus 47 is controlled, for example, based on the result of the inspection of the inspection apparatus. If a segment 3b has been correspondingly classified by the inspection apparatus 44 as not meeting the quality requirements, it is carefully removed from the production process by means of the ejection apparatus 47. This can be the case, for example, if the surface properties or the geometry of segment 2 do not meet the specifications. The ejection apparatus 47 comprises a rejection drum 65 which receives a segment 3b to be ejected from the rotational body 22b, and a reject reservoir 66, in which the segments 3 ejected by the rejection drum 65 are collected. The transfer of the segment 3b to be ejected from the rotational body 22b to the rejection drum 65 takes place at synchronous speed. Therefore, the rejection drum 65 is also moved in a clocked manner. In this embodiment, the transfer takes place in the movement interval. The rejection of the segment 3b to be ejected into the reject reservoir 66 can take place in the rest interval, wherein the rejection can then also be carried out as a gentle deposit of the segment 3b to be ejected into the reject reservoir 66, for example in the form of a bowl. This enables segments 3b to be removed from the production process without product damage. This type of controlled removal of a segment 3b to be ejected prevents particles from becoming detached and swirling up.

The rejection apparatus 47 can also be used to take segment samples. For example, segments 3b taken randomly from the production process can be inspected in detail. By storing the segment samples in an orderly manner, the cause of the ejection can be determined, for example. Furthermore, targeted segment samples can also be taken, for example segment samples prepared for this purpose, so that the inspection apparatus 44 can be checked or its sensors can be calibrated.

Furthermore, the detection apparatus 45 is provided, with which the presence of a segment 3b in a transport section of a rotational body 21 can be detected. Furthermore, the detection apparatus 45 can also be designed to detect a position and/or to detect an alignment of a segment 3b on a rotational body 22, in particular in the transport section.

Furthermore, a cleaning apparatus 46a, 46b comprising two components is provided. Each of the components of the cleaning apparatus 46a and 46b is designed to clean an upper side of a segment 3b. Logically, the side of the segment 3b that lies on the rotational body 22 cannot be cleaned because it is covered by the rotational body 22. For this reason, the two components of the cleaning apparatus 46a and 46b are assigned to the adjacent rotational bodies 22c and 22d. By transferring the segment 3b from the rotational body 22c to the rotational body 22d, the segment 3b is rotated by 180° with respect to its contact surface on the respective rotational body 22c, 22d so that a first side of the segment 3b can be cleaned by the first component of the cleaning apparatus 46a, and a second side of the segment 3b can be cleaned by a second component of the cleaning apparatus 46b. The same effect can be achieved if the two components of the cleaning apparatus 46a, 46b are not assigned to immediately adjacent rotational bodies 22; in this case, an even number of further rotational bodies 22 must be provided between the rotational bodies 22 on which the cleaning takes place. This is therefore a two-sided cleaning apparatus 46a, 46b. In a corresponding manner, a two-sided inspection apparatus (not shown) can also be provided, with which, for example, the quality of the surfaces, the presence of damage and/or the presence of wrinkles can be checked.

By means of the functional units, it can be ensured that only intact and cleaned segments of the second type 3b are forwarded to the rotational body 22e.

The same functional units are also provided in a corresponding manner as a component of the first segment feed apparatus 11.

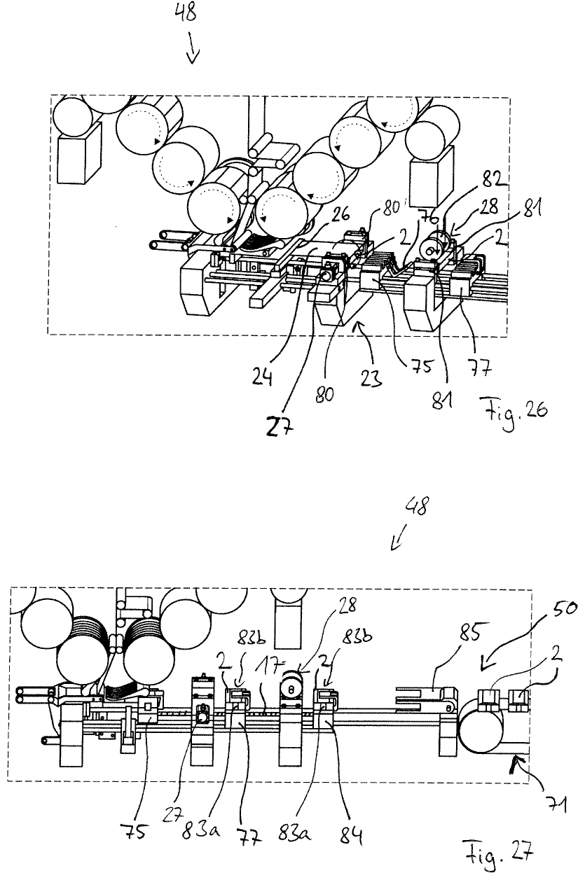

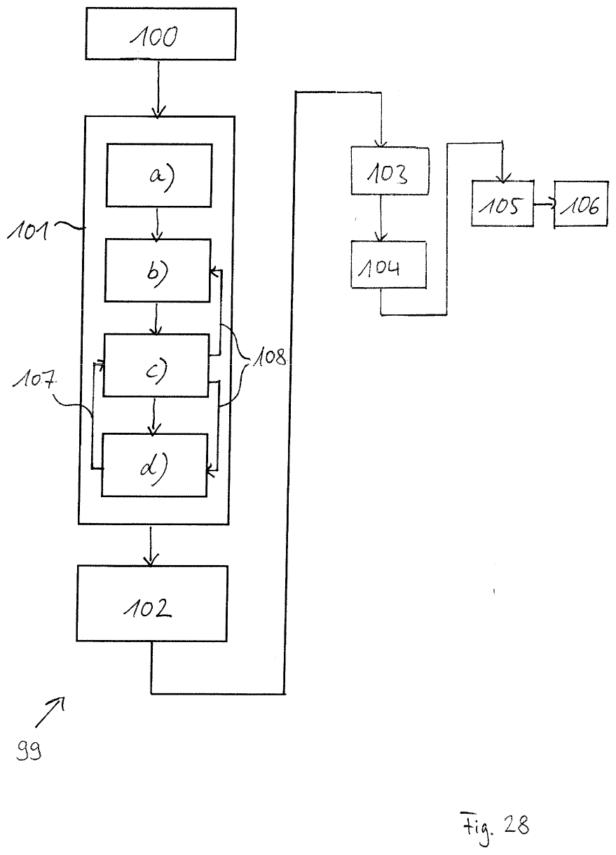

The individual manufacturing steps that are required to form a fully stacked and wrapped stack 2 (see, for example, FIGS. 26 and 27) are explained below with reference to FIGS. 9 to 27. The direction of rotation of the rotational bodies 21 and 22 is indicated by dashed arrows.

Fundamentals of the embodiment of the rotational bodies 21 and 22 as drums and the process of transferring rotational bodies 21, 22 adjacent to each other are explained here.

In principle, those rotational bodies 21, 22 of the segment feed apparatuses 11, 12 which transport separate segments 3, i.e., not the endless segment web 8, each have a plurality of transport sections in which the segments 3 are held and therefore also conveyed via a rotational movement of the rotational bodies 21, 22. The transport sections are sections of the lateral surface 14 of the respective rotational body 21, 22.

In the embodiment proposed here, the segments 3 are held on or in the respective transport section by means of a vacuum. This means that openings are provided in a surface of the respective transport section, which can be subjected to a vacuum, so that the resulting pressure difference holds the segment 3 in or on the transport section in a way that protects the product. Alternatively, the use of mechanical holding means (not shown) is also possible.

As can be seen, for example, from FIG. 9, the first and second segment feed apparatuses 11 and 12 each comprise a plurality of rotational bodies 21, 22 for conveying the separate segments 3 to the stacking table 6. To make this possible, the two adjacent rotational bodies 21, 22 must be designed to transfer segments 3. The segment 3 is released by a releasing rotational body 21, 22 and received by a receiving rotational body 21, 22. This is achieved in that at the transfer point, the holding force on the segment 3 to be transferred by the receiving rotational body 21, 22 is greater than the holding force of the releasing rotational body 21, 22. The receiving rotational body 21, 22 can simultaneously be a releasing rotational body 21, 22 and release the segment 3 to a subsequent rotational body 21, 22 at a further transfer point. In this embodiment, the transfer of a segment 3 from a releasing rotational body 21, 22 to a receiving rotational body 21, 22 takes place in the movement interval. In this case, the rotational bodies 21, 22 roll on one another without any slippage occurring between the segment 3 to be transferred and the lateral surfaces 14 of the rotational bodies 21, 22 involved in the transfer. The speeds of the rotational bodies 21, 22 involved in the transfer do not have to be constant; the freedom from slip only depends on a synchronization of the speeds such that the circumferential speeds of the two involved rotational bodies are identical at the transfer point.

Alternatively, plungers and/or sliders (not shown) can be provided in the interior of the rotational bodies 21, 22, which are designed to move the transport sections individually radially outwards in order to transfer a segment 3 to a neighboring drum.

Furthermore, the position of the segments 3 on the rotational body 21, 22 can be corrected in the circumferential direction by deliberately changing the movement profiles of one or more rotational bodies 21, 22 by means of a control and/or regulating apparatus (not shown). This is achieved by changing the rest position, i.e., the position in which segment 3 is located during the rest interval, minimally, i.e., in the range of less than one millimeter. In this way, a minimal predefined slippage is deliberately created between one or both transferring rotational bodies 21, 22, which causes a position correction of the segment 3 on the receiving rotational body 21, 22. For this purpose, significantly large gaps in the millimeter range are provided between the segments 3 on the drum. By taking advantage of these gaps, segment 3 can be brought into the correct position by stopping and/or decelerating the corresponding rotational body 21, 22.

Furthermore, position errors of the segments 3 in the direction of the longitudinal axis of the rotational bodies 21, 22 can also be corrected by displacing a rotational body assembly comprising at least one rotational body 21, 22, preferably also in the direction of the axis of rotation of the rotational bodies 21, 22.

Finally, the alignment of a segment 3 can also be corrected, i.e., if it is rotated in comparison to the actual alignment. Such a correction of the alignment of a segment 3 can be carried out by rotating a rotational body assembly comprising at least one rotational body 21, 22. The axis of rotation is also adjusted with a rotational movement component. This can be done, for example, by means of a turntable. For adjustment, an actuator is provided which is controlled by means of a control signal from the control and/or regulating apparatus.

The actual position and/or the actual alignment of the segment 3 can be detected, for example, by the above described detection apparatus 45. The actual position and/or the actual alignment is then transmitted as an input variable to the control and/or regulation unit (not shown) so that the need for and degree of alignment and/or position correction can be determined. The corresponding correction can then be made by one or more of the above-described measures.

Furthermore, individual or all of the rotational bodies 21, 22 of the segment feed apparatuses 11 and/or 12 can also be designed as a pitch change drum, which is not shown here. This means that the distance between the segments 3 can be increased in the circumferential direction and/or in the radial direction on the rotational body 21, 22. This allows certain process steps that are carried out on the segments 3 on the rotational bodies 21 and 22 to be carried out more efficiently. Regarding the design of the pitch change drum, reference is made to DE 10 2021 207 349 A1. There, in FIG. 2 and in paragraphs [0035] to [0037], a pitch change drum is described in which its transport segments are displaceable in the radial direction. Furthermore, in FIG. 4 and in paragraphs [0039] to [0041] a pitch change drum is described in which the transport segments are displaceable in the circumferential direction.

FIG. 9 shows how, in a clocked movement, the segments of the first type 3a, i.e., the anode sheets, are fed to the stacking table 6 by the first segment feed apparatus 11, and the segments of the second type 3b, i.e., the cathode sheets, are fed to the stacking table 6 by the second segment feed apparatus 12. The first and the second segment feed apparatuses 11, 12 are designed such that the segments of the first and second type 3a and 3b are fed to the stacking table 6 on separate conveying paths, i.e., without the conveying paths of the first and second segments 3a and 3b crossing each other. The first and the second segment feed apparatuses 11 and 12 feed the segments 3a and 3b alternatingly to the stacking table 6. Therefore, a cycle in which a segment of the first type 3a is fed from the first segment feed apparatus 11 to the stacking table 6 is followed by a further cycle in which a segment of the second type 3b is fed from the second segment feed apparatus 12 to the stacking table 6. Due to the clocked feed, a cycle can also be deliberately skipped, for example when a segment 3 is ejected from the production process by means of the ejection apparatus 47 in the first and/or second segment feed apparatus 11, 12. The omission of a cycle can also be used to form an asymmetric stack 2 in which the first and the last segment 3 in the stack are each formed by a segment of the first type 3a, i.e., by an anode sheet.

In this exemplary embodiment, the segments of the first type 3a are fed from the right and the segments of the second type 3b from the left. In principle, however, a reverse feed is also conceivable. The material web 4 in the form of the separator is fed to the stacking table 6 by the material web feed apparatus 10.

In FIG. 9, it can also be seen that both the first and the second segment feed apparatus 11 and 12 each comprise a transfer apparatus 31, 32 in the form of a pivoting lever, which is rotatably mounted about an axis of rotation. The transfer apparatuses 31 and 32 each receive segments 3a and 3b from a rotational body 21, 22, which is referred to below as transfer rotational bodies 41 and 42. Therefore, the segments 3a and 3b are first conveyed by means of rotational bodies 21, 22 in the form of transport drums in the direction of the stacking table 6 until they have reached the last rotational body 21, 22 which forms the transfer rotational body 41, 42. The transfer apparatus 31, 32 then takes the segment 3a, 3b from the transfer rotational body 41, 42 and deposits the segment 3a, 3b on the stacking table 6. The functioning of the transfer apparatuses 31, 32 is explained in detail below.

The pivoting lever can, for example, also comprise a 4- or 5-joint mechanism as well as an additional drive (not shown) so that more degrees of freedom are available for crafting its movement curve.

Furthermore, in FIG. 9, a folding apparatus 15 comprising a static pair of rollers 68 and a movable pair of rollers 69 is provided. Within the meaning of this application, a static pair of rollers 68 is understood to mean a pair of rollers in which the position of the axes of rotation is not adjusted during operation. Accordingly, a movable pair of rollers 69 within the meaning of this application is to be understood as a pair of rollers whose axes of rotation can be displaced so that the material web 4 guided by the movable pair of rollers 69 can be deflected into different positions. As shown in FIG. 9, the movable pair of rollers 69 allows the deflection of the material web 4 in a kind of pendulum movement.

FIG. 9 also shows that a layer of material web 4 is stretched over the stacking table 6. By deflecting the movable pair of rollers 69 to the left, the upper side of the material web 4 stretched over the stacking table 6 is kept free.

FIG. 10 shows that by a pivoting movement of the transfer apparatus 31, a segment of the first type 3a can be placed on the stacking table 6, more precisely on the material web 4 stretched over the stacking table 6. The transfer rotational body 41 of the first segment feed apparatus 11 has recesses 67. The outer contour of the associated transfer apparatus 31 is designed such that the transfer apparatus 31 engages in the recesses 67 of the transfer rotational body 41 when receiving a segment of the first type 3a. By means of the transfer apparatus 31, the segment 3a is taken by the transfer rotational body 41 by a combing movement and can therefore be deposited in a positionally accurate manner on the stacking table 6.

In FIG. 11, the transfer apparatus 31 is again engaged with the recesses 67 of the transfer rotational body 41. During the rest phase, another segment of the first type 3a can then be taken by the transfer apparatus 31. The transfer apparatus 31 performs a back-and-forth movement during the process of picking up a new segment 3a and delivering the segment 3a to the stacking table 6. By the upwards pivoting movement of the transfer apparatus 31, the segment of the first type 3a deposited in a positionally accurate manner on the stacking table 6 can be seen. At this moment, the edges of stack 2 are detected and evaluated by cameras (not shown), preferably by exactly four cameras, for a positioning check on the stacking table. If the position of the edges does not correspond to a target value, i.e., a faulty stack is detected, the stacking process is aborted by pausing the segment feed apparatuses 11 and 12 and ejecting the partial stack. Then a new stack 2 is formed.

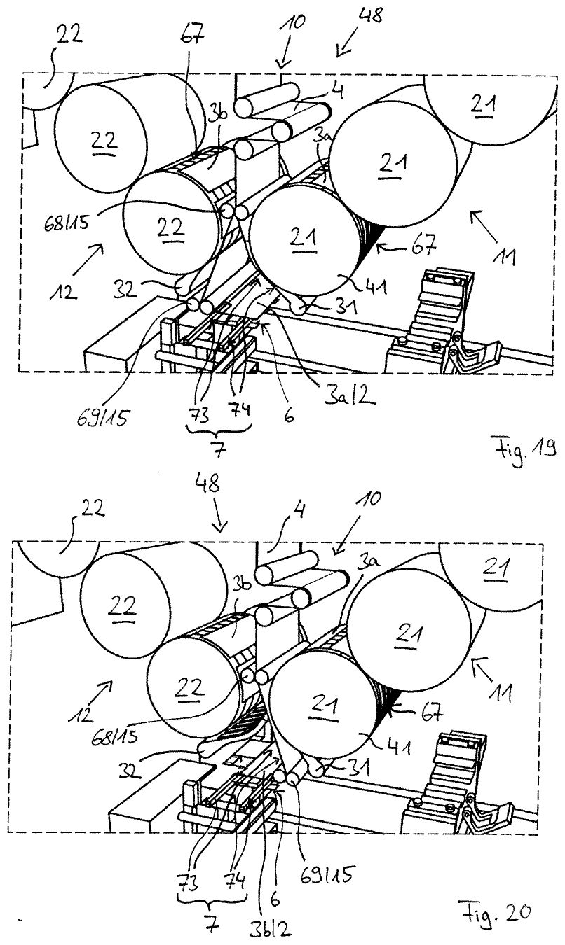

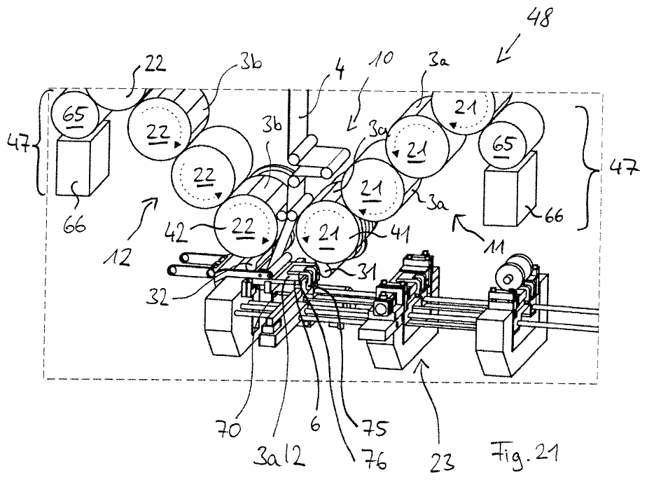

In order for the segment of the first type 3a deposited by the transfer apparatus 31 to remain in the position shown in FIG. 11, a hold-down apparatus 7, not shown in FIG. 11, is provided, which will be explained in detail later with reference to FIGS. 19 and 20.

FIG. 12 shows the removal of the segment of the second type 3b from the transfer rotational body 42 of the second segment feed apparatus 12 by means of the transfer apparatus 32 and the deposition on the stacking table 6. This is done exactly as with the segments of the first type 3a, which are fed by the first segment feed apparatus 11. Accordingly, reference is made to the relevant statements. In FIG. 12, the transfer apparatus 32 in the form of a pivoting lever engages in the recesses 67 of the transfer rotational body 42. By this insertion of the transfer apparatus 32 into the transfer rotational body 42, the segment of the second type 3b is received by the transfer apparatus 32 in the rest interval. At this time, the transfer apparatus 32 is also engaged with the transfer rotational body 42 assigned thereto.

FIG. 13 shows how the segment of the second type 3b is deposited in a positionally accurate manner on the stacking table 6 by means of the transfer apparatus 32.

FIG. 14 shows how the transfer apparatus 32 pivots upwards after the segment 3b of second type has been deposited on the stacking table 6, so that its outer contour again engages in the recesses 67 of the transfer rotational body 42. The transfer apparatus 31 remains in the position in which it engages with the recesses 67 of the transfer rotational body 41.

In this way, the segments of the first and second type 3a and 3b can be deposited alternatingly, i.e., the segments of the first type 3a from the right and the segments of the second type 3b from the left, on the stacking table 6. Furthermore, the deposition of the segments of the first and second type 3a and 3b can be carried out alternatingly, starting with a segment of the first type 3a in the form of an anode sheet. The last segment 3 placed on stack 2 is also a segment of the first type 3a, i.e., an anode sheet.

In order to ensure the mutual and alternating deposition of the segments of the first and second type 3a and 3b, when a segment of the first type 3a is removed from the transfer rotational body 31, the remaining rotational bodies 21 of the first segment feed apparatus 11 also stop; they only convey the next segment of the first type 3a back to the receiving point of the transfer rotational body 41 when the transfer apparatus 31 engages again in the recesses 67 of the transfer rotational body 41. During the deposition of a segment of the first type 3a by means of the transfer apparatus 31 onto the stacking table 6, a segment of the second type 3b is positioned by means of the rotational body 22 of the second segment feed apparatus 12 such that it is located on the transfer rotational body 42 in a delivery point from which the transfer apparatus 32 can receive the segment of the second type 3b. By alternatingly preparing, removing and depositing the segments of the first and second type 3a and 3b by means of the first and second segment feed apparatuses 11 and 12, a high deposition rate of the segments 3 can be achieved.

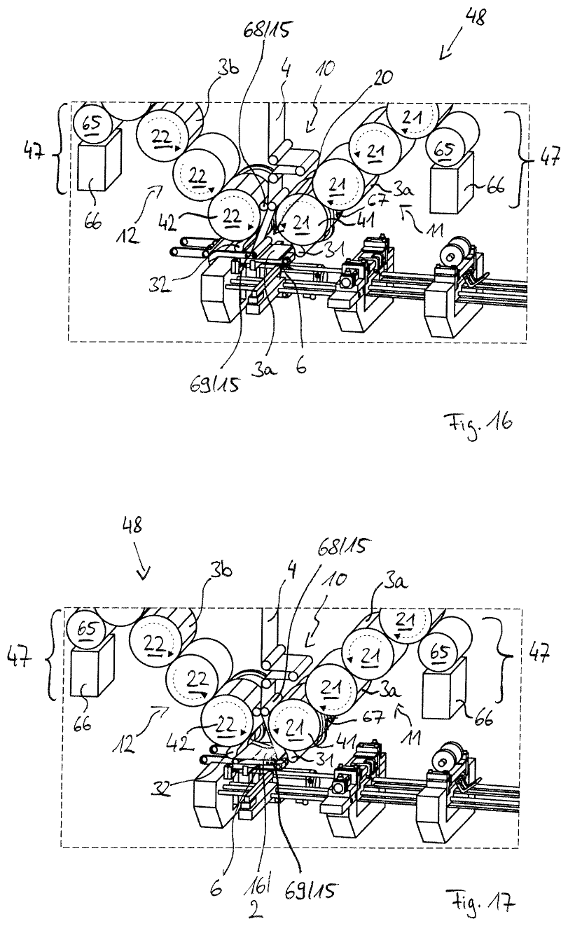

FIG. 15 shows in detail the deposition of a segment of the first type 3a on the stacking table 6 by the transfer apparatus 31. In order to ensure that the segment 3a and also a segment of the second type 3b are always deposited at the same height despite the increasing stack height, a lifting apparatus 70 is provided with which the stacking table 6 can be adjusted in the vertical direction. In addition, the stacking table 6 can be designed to be horizontally displaceable and/or rotatable about a vertical axis in order to correct positioning errors that were detected on the drum transport path. After a segment of the first or second type 3a and 3b has been deposited on the stacking table 6, the lifting apparatus 70 lowers the stacking table 6 by the height of the last deposited segment 3 and the height of the last deposited material web 4. By lowering the stacking table 6 layer by layer, the deposit height for the deposition of all segments 3 remains constant so that the transfer apparatuses 31 and 32 can each perform a constant depositing movement.

With reference to FIGS. 16 to 18, it is explained below how the material web 4 is guided in a zigzag manner around the segments 3 deposited on the stacking table 6 by means of the transfer apparatuses 31.

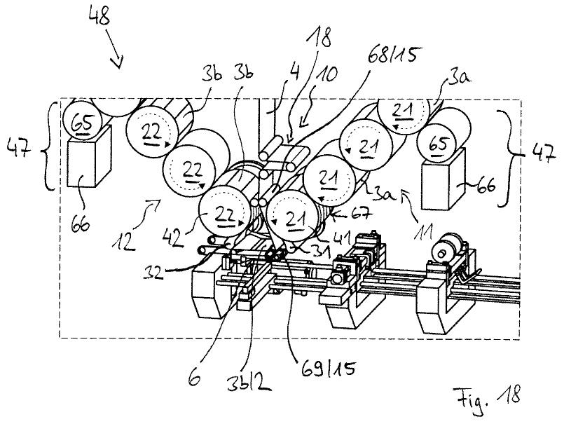

FIG. 17 shows that the material web 4 is fed to the stacking table 6 from above by means of the material web feed apparatus 10. In so doing, the material web 4 is guided centrally between the transfer rotational bodies 41 and 42 to the stacking table 6. The stacking table 6 and the two transfer rotational bodies 41 and 42 define a folding space 20 in which the material web 4 can perform a folding movement guided by the folding apparatus 15.

In FIG. 16, the material web 4 is deflected to the left, i.e., in the direction of the transfer rotational body 31, by the movable pair of rollers 69 of the folding apparatus 15. This is done by utilizing the folding space 20 because the material web 4 is guided to just before the transfer rotational body 42. This creates sufficient space for the depositing movement of the transfer apparatus 31. The deflection angle of the material web 4 is defined by the static pair of rollers 68 and the position of the movable pair of rollers 69.

FIG. 17 shows the position in which the material web 4 is deflected to the right, i.e., in the direction of the transfer rotational body 31, by means of the movable pair of rollers 69. By the movement of the movable pair of rollers 69, firstly a section 16 of the material web 4 is placed around the deposited segment of the first type 3a (see FIG. 16) to form a fold 5 (see FIG. 1). Secondly, sufficient space is created so that a segment of the second type 3b can be deposited on the stack 2 by means of the transfer apparatus 32; see FIG. 18.

After the segment of the second type 3b has been placed on the stacking table 6, as shown in FIG. 18, the movable pair of rollers 69 is moved again in the direction of the transfer rotational body 42 so that the material web 4 is also guided around the segment of the second type 3b, forming a fold 5 (see FIG. 1).

By the back-and-forth movement of the movable pair of rollers 69 as shown in FIGS. 16 to 18, the material web 4 can be laid in a zigzag manner around the alternatingly deposited segments of the first and second type 3a and 3b. In the embodiment shown here, the movable pair of rollers 69 is moved back and forth in a linear movement. As an alternative to the linear movement, the movable pair of rollers 69 can also be moved in an arc over the stacking table 6. An arcuate movement has the advantage that an additional distance can be formed between the movable pair of rollers 69 and the stack surface during the movement. In this way, a collision with a hold-down apparatus 7 (see FIGS. 19 and 20) can be prevented. The back-and-forth movement of the movable pair of rollers 69 occurs independently of the type of movement by means of an actuator (not shown).

Furthermore, FIG. 18 shows that the material web feed apparatus 10 comprises the compensation apparatus 18 which is designed to compensate for any slack in the material web 4 that could occur due to the back-and-forth movement of the movable pair of rollers 69. The web tension of the material web 4 is maintained by the compensation apparatus 18. For this purpose, the compensation apparatus 18 comprises a dancer roller 72, with regard to the functioning of which reference is made to the dancer roller 62 of the second segment feed apparatus 12 (see FIG. 6). Instead of the dancer roller 62, the compensation apparatus 18 can also have a different type of buffer or an eccentric.

The structure and function of the hold-down apparatus 7 are explained below with reference to FIGS. 19 and 20. The hold-down apparatus 7 comprises four hold-down fingers, two of which are assigned to a first hold-down finger pair 73 and the two remaining to a second hold-down finger pair 74. The two hold-down fingers of the first and second hold-down finger pairs 73 and 74 are operated synchronously.

The hold-down fingers are designed to fix the uppermost segment 3 of the stack 2 about to be formed on the stacking table 6 immediately after its deposition by the transfer apparatus 31, 32. The hold-down fingers of the first and second hold-down pair 73, 74 can be in pairs in a hold-down position or in a release position. If the first hold-down finger pair 73 is in the hold-down position, then its two hold-down fingers fix the uppermost segment 3. If the first hold-down finger pair 73 is in the release position, then this fixation of the uppermost segment 3 is canceled. This applies correspondingly to the second hold-down finger pair 74.

Each of the hold-down fingers comprises an edge around which the material web 4 is looped during folding. In the fixing position, this edge projects beyond the long edge of the upper segment 3 such that the material web 4 rests against the edge of the hold-down finger during the formation of the fold. In other words: The hold-down finger is placed with a defined overhang relative to the stack 2. This can prevent the material web 4 from being folded directly around the edge of the uppermost segment 3 and ensures a defined wrap.

By moving the movable pair of rollers 69, the material web 4 folds alternatingly around the first and second hold-down finger pair 73 and 74. The first hold-down finger pair 73 is designed to fix a segment of the first type 3a, which is deposited by the transfer apparatus 31. In contrast, the second hold-down finger pair 74 is designed to fix a segment of the second type 3b, which is deposited by the transfer apparatus 32. For this purpose, the first hold-down finger pair 73 projects beyond the uppermost segment 3 in the hold-down position on the longitudinal side facing the transfer apparatus 32. Accordingly, the second hold-down finger pair 74 projects beyond the uppermost segment 3 in the hold-down position on the longitudinal side facing the transfer apparatus 31.

The fixing of the uppermost segment 3 takes place alternatingly and in a temporally overlapping manner with the respective transfer apparatus 31 or 32, which only moves back again when the first or second hold-down finger pair 73, 74 fixes the uppermost segment 3. In other words: After the deposition of a segment of the first type 3a on the stacking table 6 by the transfer apparatus 31 of the first segment feed apparatus 11, the deposited segment of the first type 3a is fixed by the first hold-down finger pair 73 arranged here on the left (see FIG. 19). The material web 4 swings, guided by the movable pair of rollers 69 of the folding apparatus 15, to the right side, i.e., in the direction of the transfer apparatus 31 so that the left folding edge of the material web 4 is formed. After a segment of the second type 3b has been deposited on the stacking table 6 by the transfer apparatus 32 of the second segment feed apparatus 12, the deposited segment of the second type 3b is fixed by the second hold-down finger pair 74 arranged here on the right (see FIG. 20). The material web 4 then swings back to the left side, guided by the movable pair of rollers 69 of the folding apparatus 15, i.e., in the direction of the transfer apparatus 32, so that the right folding edge of the material web 4 is formed. Only after the segment of the second type 3b has been securely fixed by the second hold-down finger pair 74, the first hold-down finger pair 73 is pulled out of the stack 2, i.e., brought into the release position. Due to this temporal overlap of the first and second hold-down finger pairs 73 and 74 in the fixing position, a fixing of the segments 3 previously deposited on the stack 2 and of the stack 2 itself is ensured at all times.

FIG. 21 shows the stacking system 48 after the deposition of the last segment 3 which in this exemplary embodiment is a segment of the first type 3a, i.e., an anode sheet. A stack change then takes place, i.e., the removal of the fully formed stack 2 from the stacking table 6 by means of a conveyor carriage 75. This frees the stacking table 6 for the formation of the subsequent stack 2. The stacking table 6 and the conveyor carriage 75 are designed such that they are mated, i.e., engaged, when the finished stack 2 is picked up from the stacking table 6. In this way, the stacking table 6 only needs to be raised minimally by the lifting apparatus 70 in order to transfer the finished stack 2 to the conveyor carriage 75. Due to the fork-like design of stacking table 6 and conveyor carriage 75, the conveyor carriage 75 protrudes laterally from the mating with stacking table 6.

The conveyor carriage 75 comprises a clamping apparatus 76 which is designed to apply a clamping force to the finished stack 2. In this way, the stack 2 can be safely transported into a wrapping position 23 under the action of the clamping force.

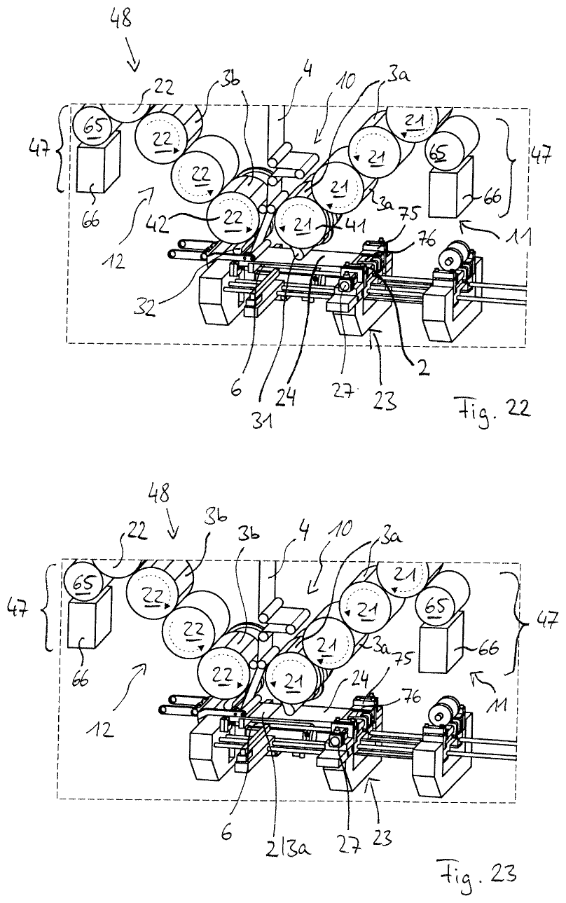

FIG. 22 shows that during the transport of the stack 2 from the stacking table 6 into the wrapping position 23, the material web 4 continues to be pulled off the material web feed apparatus 10 so that a material web tail 24 is formed. This material web tail 24 is then used to wrap the finished stack 2 in the wrapping position 23 by means of a wrapping apparatus 27.

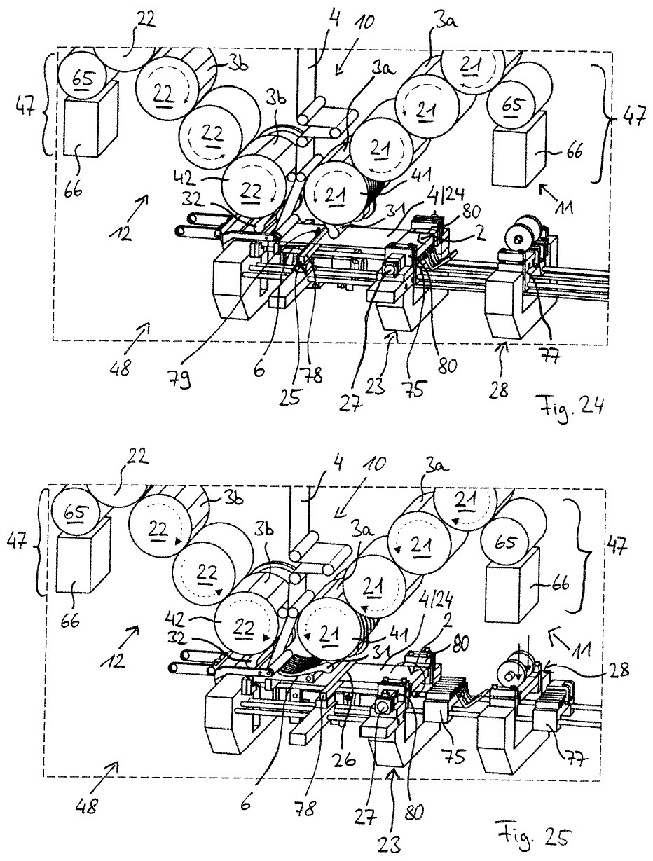

FIG. 23 shows that the formation of a new stack 2 on the stacking table 6 can already begin, i.e., with the placement of a segment of the first type 3a, as soon as the required length of the material web tail 24 has been pulled out of the material web feed apparatus 10. The required length of the material web tail 24 means the length of material web 4 that is required in the wrapping position for wrapping the stack 2 in a predefined degree of wrapping. The length of the material web tail 24 is defined by the distance between the stacking table 6 and the wrapping apparatus 27. Alternatively, an intermediate position can also be provided between the stacking table 6 and the wrapping position 23 in which the stack transport is briefly stopped as soon as the desired length of the material web tail 24 is reached. In this intermediate position, the material web tail 24 can then be fixed by means of a suction bar 78 (see FIG. 24) and separated from the remaining material web 4 by means of a separating apparatus 25 (see FIG. 24). The stack 2 is then transported further with the separated material web tail 24c to the wrapping position 23.

FIG. 24 shows the cutting of the material web 4 by means of a separating apparatus 25. In the embodiment shown here, the separating apparatus 25 comprises a blade 79 which is coupled to a suction bar 78. One can therefore speak of a suction-separating apparatus which is designed as a carriage in which the suction bar 78 is integrated into the separating apparatus 25.

In principle, however, it is also possible to position and move the separating apparatus 25 separately from the suction bar 78. The separating apparatus 25 then comprises, for example, a guide in which the blade 79 can be displaced in the transverse direction relative to the material web 4. The guide is provided in the suction bar 78. The movement of the blade 79 within the guide is effected by means of a blade actuator (not shown). However, in accordance with an alternative embodiment (not shown), the separating apparatus 25 can also be designed for hot wire cutting. Furthermore, a separating apparatus 25 comprising an ultrasonic blade can also be used.

The suction bar 78 is mounted so as to be movable relative to the material web 4 both in the transverse and in the longitudinal direction, wherein the movement of the suction bar 78 is effected by one or more suction bar actuator(s) (not shown). Furthermore, the suction bar 78 has a plurality of vacuum openings which serve to fix the material web 4 to the suction bar 78 by the effect of a vacuum.

The suction bar 78 may alternately or additionally have mechanical holding means. If the suction bar 78 has only mechanical holding means, then it can also be referred to as a holding bar.

The suction-separating apparatus works as follows:

After the material web tail 24 has been pulled out, the suction bar 78 is displaced in the transverse direction with respect to the material web 4 so that the suction bar 78 is arranged below the material web 4 over the entire width of the material web 4. Alternatively, the suction bar 78 can also wait below the material web tail 24 and then be moved upwards. In this state, the vacuum openings are subjected to a vacuum so that the material web 4 is fixed by the suction bar 78. In this fixed state, the blade 79 is guided in the transverse direction through the material web 4 so that the material web 4 is cut into two parts, namely a part which is used for zigzag folding during the formation of the subsequent stack 2 on the stacking table 6, and a final part with the material web tail 24 which is used for wrapping the stack 2 in the wrapping position 23 by means of the wrapping apparatus 27. The cutting of the material web 4 takes place at the same time or approximately at the same time, i.e., with a minimal time delay, to the formation of the next stack 2 on the stacking table 6. Through parallelization, the number of stacks 2 formed per unit of time can be increased.

FIG. 25 shows the process of wrapping the stack 2 with the material web tail 24 via a rotational movement of the stack 2 about an axis of rotation which is aligned transversely to the material web 4. For this purpose, the wrapping apparatus 27 comprises two clamping jaws 80 which can be brought into contact with the front side of the stack 2 in order to hold it by means of a clamping force. By rotating the clamping jaws 80, the stack 2 can be rotated about its longitudinal axis.

During this wrapping process, the material web tail 24 is consumed. The rotating, cuboid-shaped stack 2 results in a swelling, i.e., a discontinuous, pulling movement of the material web tail 24. A free end 26 of the material web tail 24 is tracked in a defined manner by an adapted displacement of the suction bar 78 in the direction of the wrapping position 23, wherein the application of a vacuum to the vacuum openings is maintained until the material web tail 24 is completely wrapped around the stack 2. By holding the free end 26 of the material web tail 24 by the suction bar 78 and its adapted tracking movement, a defined web tension can be maintained during the wrapping process. The wrapping process also takes place at the same time as the formation of a new stack 2 on the stacking table 6. Therefore, the required interruption of the stacking process for the stack change is defined only by the movement of the suction bar 78 when pulling the material web tail 24 and by the retraction of the suction bar 78. This minimizes the changeover time and increases the overall output of stacks 2. As an alternative to a defined, active tracking movement of the suction bar 78, the free end 26 of the material web tail 24 can also be pulled with a defined tensile stress, i.e., with the tensile force caused by the torque of the wrapping apparatus 27 on the free end; one can then speak of a torque-controlled tracking movement.

After the material web tail 24 has been completely wound, the vacuum openings of the suction bar 78 are depressurized so that the free end 26 is no longer fixed by the suction bar 78. Finally, the suction bar 78 is moved back to the starting position shown in FIG. 24 in order to be ready for the separating and fixing of a new section of the material web 4.

After the material web tail 24 has been wrapped around the stack 2 by the wrapping apparatus 27, the wrapped stack 2 is transported by means of the conveyor carriage 75 from the wrapping apparatus 27 to a fixing apparatus 28.

In FIG. 26, two conveyor carriages 75 and 77 are provided. A first conveyor carriage 75 serves to convey a stack 2 from the stacking table 6 to the wrapping apparatus 27, while a second conveyor carriage 77 serves to convey a stack 6 from the wrapping apparatus 27 to the fixing apparatus 28. The two conveyor carriages 75 and 77 are moved at the same time, i.e., while a segment 3 is transported from the stacking table 6 to the wrapping apparatus 27, a segment 3 is simultaneously conveyed from the wrapping apparatus 27 to the fixing apparatus 28. Alternatively, the two conveyor carriages 75 and 77 can also be replaced by two independent systems that perform similar movements more or less at the same time, but are independent.

The fixing apparatus 28 shown in FIG. 26 is designed to fix the wrapped material web tail 24, more precisely the outer wrapping. For this purpose, the fixing apparatus 28 in the exemplary embodiment presented here is designed to apply one or more tapes, i.e., adhesive strips, to fix the material web tail 24. Furthermore, the fixing apparatus 28 also comprises two clamping jaws 81 in order to apply a clamping force to the front of the wrapped stack 2 for holding after the wrapped stack 2 has been fed to the fixing apparatus 28 by the second conveyor carriage 77. The application of tape strips, i.e., adhesive strips, is carried out by a stamp at a standstill or by a pair of rollers 82 while the wrapped stack 2 is moved by the fixing apparatus 28. In accordance with an alternative embodiment of the stacking system 48, it is also possible to apply the tape strips by fingers; this can also be done during a movement or when the stack 2 is at a standstill.

The fixing process takes place both at the same time as the stacking process on the stacking table 6 and at the same time as the wrapping process in the wrapping apparatus 27.

The segments of the first and second type 3a and 3b used in this exemplary embodiment have conductor lugs 83a and 83b which are shown schematically in FIG. 27. In the process, an apparatus (not shown) is provided downstream from the fixing apparatus 28, with which the conductor lugs 83a of segments of the first type 3a can be connected to one another, and in the same way the conductor lugs 83b of segments of the second type 3b can be connected to one another. The conductor lugs of the first and second type 83a and 83b protrude from the front side of the stack 2. By connecting the conductor lugs 83a and 83b to each other, the stack 2 is additionally fixed. Like wrapping and fixing, this process step takes place at the same time as stacking in a downstream unit.

Furthermore, FIG. 27 shows a third conveyor carriage 84 which is designed to transport a stack 2. With the third conveyor carriage 84, a stack 2 can be conveyed from the fixing apparatus 28 or from the apparatus (not shown) for connecting the conductor lugs 83a and 83b to one another to the discharge apparatus 50.

The discharge apparatus 50 comprises a removal apparatus 85 and a conveyor belt 71. The removal apparatus 85 is designed in the form of a pivoting lever with which the stack 2 can be removed from the third conveyor carriage 84 and delivered to the conveyor belt 71. It goes without saying that the discharge apparatus 50 can also be designed differently.

The three conveyor carriages 75, 77 and 84 are connected to each other by means of a frame-like connecting structure 17 so that the three conveyor carriages 75, 77 and 84 are moved uniformly. Due to the cyclical movement profile of the conveyor carriages 75, 77 and 84 within a cycle ensured in this way, a plurality of processing apparatuses, in this case the wrapping apparatus 27 and the fixing apparatus 28, are supplied here with a stack 2 at the same time.

Of course, more than the three conveyor carriages 75, 77 and 84 can also be provided, which are then connected to the connecting structure 17. Accordingly, further processing units can then also be provided, to which stacks 2 can be fed by means of the further conveyor carriages and can be accordingly removed from there.

From the conveyor belt 86, the wrapped and taped stacks 2 can then be fed to one or more downstream process steps. Such a process step can, for example, be reweighing by means of a scale (not shown). Based on the determined mass of the wrapped and taped stack 2, an assessment of the quality of the stack 2 can then be made, on the basis of which the stack 2 then either remains in the production process or is ejected as a defective stack 2. Of course, further, additional quality controls of the stack 2 can be carried out downstream in the production process.

In principle, in contrast to the exemplary embodiment shown in FIGS. 2 to 27, only the first or the second segment feed apparatus 11 or 12 can be provided, i.e., only a single segment feed apparatus 11 or 12. In this case, the material web 4 could already be layered with individual segments of the first or second type 3a or 3b when it is fed to the stacking table 6. Only one segment 3 of a different type then needs to be fed to the stacking table 6 by means of the corresponding segment feed apparatus 11 or 12. In this way, a battery cell can also be formed with only one segment feed apparatus 11 or 12, in which the separator web is alternatingly wrapped in a zigzag manner around an anode sheet and a cathode sheet.

FIG. 28 schematically shows a method 99 for forming a stack 2. In explaining this method, reference is made to the device 1 described above.

In a method step 100, segments of the first and second type 3a and 3b as well as the material web 100 are fed to a stacking table 6. The stacking steps a) to d) are then carried out there.

In the stacking step a), a section of the material web 4 is placed directly above the stacking table 6. Subsequently, in the stacking step b), a segment of the first type 3a is deposited on the section of the material web 4 placed over the stacking table 6. Subsequently, in a stacking step c), the material web 4 is placed on the stacking table 6, forming a fold 5 around the deposited segment 3. Subsequently, in a stacking step d), a segment of the second type 3b is deposited on the section of the material web 4 that lies on the stacking table 6. In this way, a stack 2 arises as shown schematically in FIG. 1. To increase the stack height, stacking step c) follows stacking step d) again, see arrow 107. This is followed alternatingly by stacking steps b) and d), see arrows 108, each with the stacking step c) interposed.

After the stack 2 has reached the desired stack height, the material web tail 24 is formed in a method step 102.

In a method step 103, the material web 4 is then separated by means of the separating apparatus 25 and in the method step 104, it is wrapped by means of the wrapping apparatus 27. The method step 100 of stacking and the method steps 103 and 104 of separating and wrapping take place at the same time, which is illustrated graphically in FIG. 28 by the arrangement of these method steps next to each other.

This is followed by the method step 105 of fixing, which also takes place at the same time as steps 103 and 104 as well as 101. Further processing steps, such as the previously described connection of the conductor lugs 83a and 83b, are not shown here for the sake of simplicity.

Finally, in a method step 106, the wrapped and taped stack 2 is removed by means of the discharge apparatus 50. Method step 106 occurs at the same time as the preceding method steps 101, 103, 104 and 105.

A further embodiment of the device 1 is explained below, in particular with reference to FIG. 15. Otherwise, reference is made to the above embodiments.

It relates to a device 1 for the energy cell manufacturing industry for forming a stack 2 which has a plurality of segments 3 and a material web 4. The device 1 is configured and designed to fold the material web 4 in a zigzag manner and to deposit the segments 3 on the material web 4 such that in the stack 2, the segments 3 are arranged in the folds 5 of the material web 4. The device 1 has the following components: a stacking table 6 on which the stack 2 is formed; a material web feed apparatus 10 that is configured and designed to convey the material web 4 to the stacking table 6; a first segment feed apparatus 11 that is configured and designed to convey sections 3 to the stacking table 6; and a second segment feed apparatus 12 that is configured and designed to convey sections 3 to the stacking table 6. The first segment feed apparatus 11 has a plurality of rotational bodies 21 which are mounted rotatably about an axis of rotation and which are each configured and designed to convey segments 3 via a rotational movement. The second segment feed apparatus 12 also has a plurality of rotational bodies 22 which are rotatably mounted about an axis of rotation and which are each configured and designed to convey sections 3 via a rotational movement.

The rotational bodies 21 of the first segment feed apparatus 11 each have a circumferential surface and are configured and designed to receive one segment 3 or a plurality of segments 3 lying on their circumferential surface.

The rotational bodies 22 of the second segment feed apparatus 12 each have a circumferential surface and are configured and designed to receive one segment 3 or a plurality of segments 3 in contact with their circumferential surface.

The circumferential surface of the rotational body 21 of the first segment feed apparatus 11 extends in the circumferential direction, preferably in a curved shape.

The circumferential surface of the rotational body 22 of the second segment feed apparatus 12 extends in the circumferential direction, preferably in a curved shape.

The rotational bodies 21, 22, on which individual segments 3 are transported, are each designed as a drum, the lateral surface 14 of which has a plurality of transport sections on which the segments 3 are conveyed.

The last rotational body 21 of a plurality of rotational bodies 21 of the first segment feed apparatus 11 in the conveying direction is designed as a transfer rotational body 41.

The last rotational body 22 of a plurality of rotational bodies 22 of the second segment feed apparatus 12 in the conveying direction is designed as a transfer rotational body 42.

The first segment feed apparatus 11 has a transfer apparatus 31 which is configured and designed to deposit segments 3 on the stacking table 6.

The second segment feed apparatus 12 has a transfer apparatus 32 which is configured and designed to deposit segments 3 on the stacking table 6.

The last rotational body 21 of the first segment feed apparatus 11 in the conveying direction forms the transfer rotational body 41 from which the transfer apparatus 31 of the first segment feed apparatus 11 takes a segment 3.

The last rotational body 22 of the second segment feed apparatus 12 in the conveying direction forms a transfer rotational body 42, from which the transfer apparatus 32 of the second segment feed apparatus 12 takes a segment 3.

FIG. 15 shows that the first segment feed apparatus 11 has a transfer apparatus 31 in the form of a pivoting lever SH that is rotatably mounted about an axis of rotation.

The transfer apparatus 31 of the first segment feed apparatus 11 has a vacuum holding system UHS for holding a segment 3.

FIG. 15 shows that the second segment feed apparatus 12 has a transfer apparatus 32 in the form of a pivoting lever SH that is rotatably mounted about an axis of rotation.

The transfer apparatus 32 of the second segment feed apparatus 12 has a vacuum holding system UHS for holding a segment 3.

The vacuum holding system UHS has a vacuum supply line UHSL which is fluidically connected to the respective transfer apparatus 31 and 32.

The vacuum holding system UHS has a vacuum control station UHSS which controls the application of vacuum to the respective transfer apparatus 31, 32, in particular switches the vacuum on or off.

The vacuum holding system UHS has one vacuum channel or a plurality of vacuum channels UHSK which extend into and/or through the transfer apparatuses 31, 32 and are preferably provided with openings arranged on an outer boundary surface and/or in the region of an outer boundary surface of the transfer apparatus 31, 32 in order to hold a segment 3 by means of vacuum.

The transfer apparatus 31, 32 shown in FIG. 15 is designed in the form of a pivoting lever SH, which has a bearing end SHLE and a free end SHFE. At the bearing end SHFE, the pivoting lever SH is mounted so that it can rotate about an axis of rotation, see FIG. 15. The bearing end SHFE of the pivoting lever SH has a bearing shaft SHLA for supporting the pivoting lever SH about the axis of rotation and for rotating or pivoting the pivoting lever SH about the axis of rotation by means of an actuator, which in this exemplary embodiment is designed as a motor. One vacuum channel or a plurality of vacuum channels UHSK-LA are arranged in the bearing shaft SHLA. The bearing shaft SHLA has a connecting piece for connecting one vacuum channel or a plurality of vacuum channels UHSK-LA to a vacuum supply line UHSL.

A plurality of tines ZK extend in the form of a fork from the bearing end SHFE of the pivoting lever SH to the free end SHFE of the pivoting lever SH. In the embodiment shown in FIG. 15, the tines are of equal length. In principle, in accordance with a further embodiment, these can also be of different lengths; in this case, for example, tines lying to the outside are shorter than tines lying to the inside.

FIG. 15 shows that the tines ZK form a convexly curved support surface TF for a segment 3, namely in the direction from the bearing end SHLE of the pivoting lever towards the free end SHFE of the pivoting lever. The convex curvature of the support surface is visible in a sectional plane that is orthogonal to the axis of rotation of the pivoting lever and runs through the support surface. To form the support surface TF, the tines ZK have flattened boundary surfaces which are designed such that a segment 3, at least in partial areas of the segment 3, lies flat against a flattened boundary surface, here against a flat boundary surface. On the side opposite the support surface TF, the tines are concave in the direction from the bearing end SHLE of the pivoting lever to the free end SHFE of the pivoting lever. The concave curvature of the side opposite the support surface TF is visible in a sectional plane that is orthogonal to the axis of rotation of the pivoting lever and passes through the support surface. The distance between the tines ZK of the pivoting lever SH is adapted to the recesses 67 of the respective transfer rotational body 41, 42 such that the tines ZK of the pivoting lever SH are movable with play relative to the recesses 67 of the respective transfer rotational body 41, 42.

One of the tines ZK or a plurality of the tines ZK has a vacuum channel or a plurality of vacuum channels UHSK-ZI which extend into and/or through the tine ZK and are provided with openings which are arranged on an outer boundary surface and/or in the region of an outer boundary surface of the tine ZK, namely on or in a support surface TF, in order to hold a segment 3 by means of a vacuum. A vacuum channel UHSH-ZI of a tine ZK is connected to a vacuum channel UHSK-LA of the bearing shaft SHLA of the pivoting lever. However, a vacuum channel UHSH-ZI of a tine ZK can also be connected to a plurality of vacuum channels UHSK-LA of the bearing shaft SHLA of the pivoting lever. A vacuum channel UHSK-LA of the bearing shaft SHLA of the pivoting lever can be connected to a vacuum channel UHSH-ZI of a tine ZK. A vacuum channel UHSK-LA of the bearing shaft SHLA of the pivoting lever can be connected to a plurality of vacuum channels UHSH-ZI of a tine ZK or to a plurality of vacuum channels UHSH-ZI of a plurality of tines ZK.

The transfer rotational bodies 41, 42 have vacuum channels ÜKK which extend into and/or through the transfer rotational body 41, 42 and are provided with openings which are arranged on an outer boundary surface and/or in the region of an outer boundary surface of the transfer rotational body 41, 42 in order to hold a segment 3 by means of vacuum.

A transfer of a segment 3 from a transfer rotational body 41, 42 to a transfer apparatus 31, 32 takes place with a gradual switching on and off of the vacuum supply in vacuum channels ÜKK of the transfer rotational body 41, 42 and the vacuum supply in vacuum channels UHSK of the transfer apparatus 31, 32, namely the vacuum supply in the vacuum channel UHSK-LA or vacuum channels UHSK-LA of the bearing shaft SHLA of a pivoting lever and in the vacuum channel UHSK-ZI or the vacuum channels UHSK-ZI of the tine ZK or the tines ZK of a pivoting lever.

When a segment 3 is transferred from a transfer rotational body 41, 42 to a transfer apparatus 31, 32, a vacuum is applied to the vacuum channels UHSK of the transfer apparatus 31, 32 at a time A. At the vacuum channels ÜKK of the transfer rotational body 41, 42, which hold the segment 3 to be transferred, the applied vacuum is maintained beyond the time A for a time period TX and only after the expiration of the time period TX is a vacuum supply to the vacuum channels ÜKK of the transfer rotational body 41, 42 switched off. During the time period TX, the segment 3 is held by means of a vacuum acting via the openings of the vacuum channels ÜKK of the transfer rotational body 41, 42 and via a vacuum acting the openings of the vacuum channels UHSK of the transfer apparatus 31, 32. A transfer apparatus 31, 32 is configured and designed to be externally actuated, namely by means of an actuator in the form of a motor, such that a segment 3 can be withdrawn from the transfer rotational body 41, 42 against a holding force exerted on the segment 3 by a transfer rotational body 41, 42.

When a segment 3 is transferred from the transfer rotational body 41, 42 to the pivoting lever SH 31, 32, a vacuum is applied at a time A to the vacuum channel UHSK-LA or to the vacuum channels UHSK-LA of the bearing shaft SHLA and to the vacuum channel UHSK-ZI or to the vacuum channels UHSK-ZI of the tine ZK or the tines ZK of the pivoting lever SH 31, 32. At the vacuum channels ÜKK of the transfer rotational body 41, 42, which hold the segment 3 to be transferred, the applied vacuum is maintained beyond the time A for a time period TX and only after the expiration of the time period TX is a vacuum supply to the vacuum channels ÜKK of the transfer rotational body 41, 42 switched off. During the time period TX, the segment 3 is held by means of a vacuum acting via the openings of the vacuum channels ÜKK of the transfer rotational body 41, 42 and via the openings of the vacuum channel UHSK-ZI or via the openings of the vacuum channels UHSK-ZI of the tine ZK or the tine ZK of the pivoting lever SH. The pivoting lever SH is configured and designed to be externally actuated, namely by means of an actuator in the form of a motor, such that a segment 3 can be withdrawn from the transfer rotational body 41, 42 against a holding force exerted on the segment 3 by a transfer rotational body 41, 42.

A convexly curved support surface TF of a pivoting lever SH for a segment 3, 3a, 3b, which is formed by tines ZK and extends in the direction from a bearing end SHLE of the pivoting lever to a free end SHFE of the pivoting lever SH, has a radius of curvature which corresponds to the radius of a transfer rotational body 41, 42, namely the radius of a transfer rotational body 41, 42. In accordance with a further embodiment, the radius of curvature need not correspond to the radius of the transfer rotational bodies 41, 42; in this case, the radius of curvature of the pivoting lever SH does not deviate from the radius of the transfer rotational body 41, 42 cooperating with the respective pivoting lever SH by more than 40%, preferably not more than 20%, particularly preferably not more than 10%.

The material web feed apparatus 10 has a folding apparatus 15. The folding apparatus 15 is configured and designed to place a section of the material web 4 over and/or around the respective uppermost segment 3 of the stack 2 located on the stacking table 6 by a back-and-forth movement. The back-and-forth movement occurs in the form of a linear movement or as a pivoting movement. The folding apparatus 15 has a movably mounted pair of rollers 69 through which the material web 4 is guided. The material web 4 is to be guided continuously between the rollers of the movable pair of rollers 69. The movable pair of rollers 69 is provided so as to be movable in an arc over the stacking table 6.

### LIST OF REFERENCE SIGNS

1 Device
2 Stack
3 Segment
4 Material web
5 Fold
6 Stacking table
7 Hold-down apparatus
8 Endless segment web
9 Compensation apparatus
10 Material web feed apparatus
11 First segment feed apparatus
12 Second segment feed apparatus
13 Separating apparatus
14 Lateral surface
15 Folding apparatus
16 Section
17 Connecting structure
18 Compensation apparatus
19 Compensation apparatus
20 Folding space
21 Rotational body
22 Rotational body
23 Wrapping position
24 Material web tail
25 Separating apparatus
26 Free end
27 Wrapping apparatus
28 Fixing apparatus
29 Material supply
30 Splicing apparatus
31 Transfer apparatus
32 Transfer apparatus
33 Coil
34 Coil
35 Coil
36 Unit
37 Unit
38 Unit
39 Coil holder
40 Coil holder
41 Transfer rotational body
42 Transfer rotational body
43 Web edge control apparatus
44 Inspection apparatus
45 Detection apparatus
46 Cleaning apparatus
47 Ejection apparatus
48 Stacking system
49 Material storage
50 Discharge apparatus
51 Turntable
52 Traction roller
53 Stacking system
54 Housing
55 First region
56 Second region
57 Rotational body
58 Plane
59 Plane
60 Clocked movement
61 Deflection roller
62 Dancer roller
63 Roller
64 Traction roller
65 Rejection drum
66 Reject reservoir
67 Recesses
68 Pair of rollers
69 Pair of rollers
70 Lifting apparatus
71 Conveyor belt
72 Dancer roller
73 First hold-down finger pair
74 Second hold-down finger pair
75 Conveyor carriage
76 Clamping apparatus
77 Conveyor carriage
78 Suction bar
79 Blade
80 Clamping jaws
81 Clamping jaws
82 Pair of rollers
83 Conductor lug
84 Conveyor carriage
85 Removal apparatus
99 Method
100 Method step
101 Method step
102 Method step
103 Method step
104 Method step
105 Method step
106 Method step
107 Arrow
108 Arrow
a) Stacking step
b) Stacking step
c) Stacking step
d) Stacking step
F1 First conveying section
F2 Second conveying section
F3 Third conveying section

1. A device for the energy cell manufacturing industry for forming a stack comprising a plurality of segments and a material web, wherein:
the device is designed to fold the material web in a zigzag manner and to deposit the segments on the material web such that in the stack, the segments are arranged in the folds of the material web, wherein the device comprises the following components:
a stacking table on which the stack is formed,
a material web feed apparatus which is designed to convey the material web to the stacking table, and
a first and/or a second segment feed apparatus, each of which is designed to convey sections to the stacking table, wherein
the first and/or the second segment feed apparatus each comprise at least one rotational body rotatably mounted about an axis of rotation and is designed to convey sections via a rotational movement.

2. The device according to claim 1, wherein
the one rotational body or at least one of the plurality of rotational bodies of the first and/or the second segment feed apparatus conveys segments in a clocked movement; and/or
the device comprises a first and a second segment feed apparatus, and wherein
the device is designed to alternatingly deliver a segment of the first segment feed apparatus and the second segment feed apparatus to the stacking table to form the stack; and/or
the first and/or the second segment feed apparatus each comprise a first conveying section, and wherein
the device is designed to convey an endless segment web, from which the segments are formed, in the first conveying section at a constant or approximately constant conveying speed; and/or
the at least one rotational body of the first and/or the second segment feed apparatus is a drum which is designed to hold and convey a segment on its lateral surface by means of vacuum; and/or
the material web feed apparatus comprises a folding apparatus which is designed to place a section of the material web over and/or around the respective uppermost segment of the stack located on the stacking table by means of a back-and-forth movement; and/or
the first and/or the second segment feed apparatus each comprise at least three rotational bodies, wherein
at least three of the rotational bodies of the first and/or second segment feed apparatus are arranged in a linear configuration, and wherein
the linear configuration is defined such that the axes of rotation of all rotational bodies of the linear configuration extend in a common plane; and/or
the stacking table is mounted during the stacking process such that movements of the stacking table with a horizontal directional component are prevented, or the stacking table can be moved by a maximum of 2 mm in the horizontal direction to compensate for position errors when depositing segments; and/or
the stacking table is movable in the vertical direction such that the reloading of segments and/or material web takes place at a constant height during stack formation; and/or
the device comprises a material supply which is designed to supply the first and/or the second segment feed apparatus as well as the material web feed apparatus each with an endless web of the corresponding material which is provided in the wrapped state as a coil; and/or
the first and/or the second segment feed apparatus comprise one or more of the following functional units:
an inspection apparatus arranged to check a segment;
a detection apparatus which is arranged to detect the presence of a segment, to detect a position and/or to detect an alignment of a segment on a rotational body;
a cleaning apparatus which is designed to clean a segment; and/or
an ejection apparatus which is designed to eject a segment from the production process.

3. The device according to claim 1, wherein
the first and/or the second segment feed apparatus each comprise a transfer apparatus which is designed to deposit segments on the stacking table by a back-and-forth movement.

4. The device according to claim 3, wherein
a rotational body of the first and/or the second segment feed apparatus forms a transfer rotational body from which the transfer apparatus of the first and/or the second segment feed apparatus takes a segment.

5. The device according to claim 4, wherein
the transfer rotational body of the first and/or the second segment feed apparatus has recesses which enable engagement of an outer contour of the associated transfer apparatus, so that the transfer apparatus engages in the recesses of the transfer rotational body when receiving a segment; and/or
the device comprises a first and a second segment feed apparatus and wherein
the transfer rotational bodies of the first and second segment feed apparatuses are arranged such that the material web is guided therebetween by means of the material web feed apparatus.

6. (canceled)

7. The device according to claim 3, wherein
the stacking table comprises a hold-down apparatus, and wherein
the hold-down apparatus is designed to temporarily fix a segment deposited on the stacking table by the transfer apparatus of the first and/or the second segment feed apparatus.

8. (canceled)

9. The device according to claim 3, wherein
the transfer apparatus of the first and/or the second segment feed apparatus is designed to convey a segment on a curved path and/or to convey it while changing its spatial alignment.

10. (canceled)

11. The device according to claim 1, wherein
the first and/or the second segment feed apparatus each comprise a second conveying section, and wherein
the device is designed to convey the endless segment web with a clocked movement in the second conveying section.

12. The device according to claim 11, wherein
a compensation apparatus is arranged between the first conveying section and the second conveying section, and wherein
the compensation apparatus is designed to enable a transition between a constant conveying speed and a clocked movement; and/or wherein
a separating apparatus is provided in the second conveying section, which is designed to divide the endless segment web into segments and
wherein
in a third conveying section of the first and/or second segment feed apparatus, segments are conveyed with a clocked movement.

13-16. (canceled)

17. The device according to claim 1, wherein
the folding apparatus comprises a movably mounted pair of rollers through which the material web is guided; and/or
the device is designed to continuously feed the material web by means of the material web feed apparatus to a compensation apparatus from which the folding apparatus is supplied with the material web; and/or
the device comprises a first and a second segment feed apparatus, wherein
a folding space is defined by the curved lateral surfaces of the transfer rotational bodies of the first and second segment feed apparatuses and by the stacking table, and wherein
the folding apparatus deflects the material web by utilizing this folding space to carry out a folding movement.

18-22. (canceled)

23. The device according to claim 1, wherein
the device is designed to move the stack after its completion, from the stacking table into a wrapping position and/or into an intermediate position provided between the stacking table and the wrapping position, wherein
by moving the stack from the stacking table into the wrapping position or into the intermediate position, a material web tail which projects beyond the stack is pulled out of the material web feed apparatus, wherein
a separating apparatus is provided which is designed to separate this material web tail from the endless material web of the material web feed apparatus, so that the material web tail has a free end, and wherein
a wrapping apparatus is provided which is designed to wrap the finished stack with the projecting material web tail in the wrapping position.

24. The device according to claim 23, wherein
the device comprises a fixing apparatus which is designed to fix the material web tail wrapped around the stack by the wrapping apparatus; and/or
the device is designed to form a subsequent stack on the stacking table during the wrapping of the stack by means of the wrapping apparatus and/or during the separation of the material web tail from the remaining material web.

25-26. (canceled)

27. The device according to claim 1, wherein
the device comprises a first and a second segment feed apparatus, and wherein
the material supply comprises separate units so that the first and second segment feed apparatus and the material web feed apparatus can each be supplied with endless webs of different types; and/or
each of the units comprises a coil holder for an expiring coil and a coil holder for a new coil, and wherein
a splicing apparatus is provided with which a free end of an expiring coil can be connected to a free end of a new coil.

28. (canceled)

29. The device according to claim 27, wherein
when carrying out the conveying movement, a web edge control apparatus is provided downstream from the splicing apparatus, which is designed to correct the alignment and/or position of an edge of the corresponding endless web if necessary.

30. (canceled)

31. The device according to claim 2, wherein
a functional unit comprises two components, wherein the two components are assigned to different rotational bodies of a segment feed apparatus, wherein
the two components of a functional unit are assigned to mutually adjacent rotational bodies, or wherein
the two components of a functional unit are assigned to two rotational bodies, between which an even number of further rotational bodies are arranged; and/or
the functional units are assigned to the third conveying section.

32. (canceled)

33. A method for the energy cell manufacturing industry for forming a stack comprising a plurality of segments and a material web, wherein:
the material web is folded in a zigzag manner, and the segments are deposited on the material web such that in the stack, the segments are arranged in the folds of the material web, wherein
a first and/or a second segment feed apparatus is used to transport segments to a stacking position, wherein
the first and/or the second segment feed apparatus each comprise at least one rotational body rotatably mounted about an axis of rotation and is designed to transport sections via a rotational movement.

34. The method according to claim 33, wherein
an endless segment web is fed to the first and/or the second segment feed apparatus, wherein
the endless segment web is conveyed in a first conveying section at a constant conveying speed, wherein
the endless segment web is conveyed in a second conveying section in a clocked manner and is divided into segments, and wherein
the segments are conveyed in a third conveying section in a clocked manner; and or
in a stacking step a), a section of the material web is placed over the stacking table or on a segment lying on the stacking table, then
in a stacking step b) a segment of the first type is deposited on the section of the material web placed over the stacking table; subsequently
in a stacking step c), the material web is placed on the stacking table to form a fold around the deposited segment; and subsequently
in a stacking step d), a segment of the second type is deposited on the section of the material web that lies on the stacking table; and/or
after the formation of the stack, a section of the material web projects beyond the formed stack so that a material web tail with a free end is formed, and wherein
the formed stack is wrapped by means of the material web tail; and/or
the method is carried out by using a device for the energy cell manufacturing industry for forming a stack comprising a plurality of segments and a material web, wherein:
the device is designed to fold the material web in a zigzag manner and to deposit the segments on the material web such that in the stack, the segments are arranged in the folds of the material web, wherein the device comprises the following components:
a stacking table on which the stack is formed,
a material web feed apparatus which is designed to convey the material web to the stacking table, and
a first and/or a second segment feed apparatus, each of which is designed to convey sections to the stacking table, wherein
the first and/or the second segment feed apparatus each comprise at least one rotational body rotatably mounted about an axis of rotation and is designed to convey sections via a rotational movement.

35. (canceled)

36. The method according to claim 34, wherein
the stacking steps b) and d) are carried out alternatingly with the stacking step c) interposed; and wherein
this process is repeated several times.

37. The method according to claim 34, wherein
the material web is a separator, wherein
the segment of the first type is an anode sheet, and wherein
the segment of the second type is a cathode sheet.

38. The method according to claim 36, wherein
a segment of the first type is deposited as the first segment of the stack by means of method step b), and
a segment of the first type is also deposited as the last segment of the stack by means of method step b).

39. (canceled)

40. The method according to claim 34, wherein
the formation of a stack by folding the material web takes place simultaneously with the wrapping or with the separation of the material web tail of another stack at different positions.

41. (canceled)
